(19) United States
(12) Patent Application Publication
(10) Pub. No.: US 2025/0045739 A1
(43) Pub. Date: Feb. 6, 2025

(54) SYSTEMS AND METHODS FOR A PRIVATE SECTOR MONETARY AUTHORITY

(71) Applicant: Fulcrum IP Corporation, St. Petersburg, FL (US)

(72) Inventor: Douglas Jackson, Melbourne, FL (US)

(21) Appl. No.: 18/771,807

(22) Filed: Jul. 12, 2024

Related U.S. Application Data
(63) Continuation of application No. 16/824,869, filed on Mar. 20, 2020, now abandoned.
Application No. 16/824,869 is a continuation of application No. 15/701,259, filed on Sep. 11, 2017, now abandoned.
Application No. 15/701,259 is a continuation of application No. 14/211,688, filed on Mar. 14, 2014, now abandoned.
(60) Provisional application No. 61/799,053, filed on Mar. 15, 2013.

(51) Int. Cl. G06Q 20/38; G06Q 20/02

(52) U.S. Cl. CPC G06Q 20/381; G06Q 20/02; G06Q 20/023

(57) ABSTRACT

Embodiments of the present invention may provide systems and methods for administering a private sector Monetary Authority. The systems and methods may include providing access to End Users; and enabling performance of specialized Roles required for the administration of the system. The systems and methods may be self-contained for creation, holding, circulation and retirement of the Base Money such that outside money or value cannot be transmitted into or out of the system.

### CROSS-REFERENCE TO RELATED APPLICATIONS

This application is a continuation of U.S. application Ser. No. 16/824,869, filed Mar. 20, 2020, which is a continuation of U.S. application Ser. No. 15/701,259, filed Sep. 11, 2017, which is a continuation of U.S. application Ser. No. 14/211,688 filed Mar. 14, 2014, which claims benefit of priority to U.S. Provisional Application No. 61/799,053 filed Mar. 15, 2013, the contents of each of which are incorporated by reference herein in their entirety.

### FIELD OF THE INVENTION

The present invention relates to the fields of alternative currency and payment systems. More specifically, the present invention relates to systems and methods of administering a private sector Monetary Authority which issues and enables the circulation of Currencies enabling an automatically self-regulating money supply.

### BACKGROUND OF INVENTION

Problems with Financial System in General

“Inherently unstable”. Monetary arrangements constitute the core of banking and the broader financial system on which all levels of economic activity, from local to global, depend. The State has asserted control over money from its earliest emergence, influencing its nature and supply to accommodate government fiscal/financial practices and imperatives. Yet, despite a continual accretion of monetary insights and technical advancements of the art, money and its nexus with banking and finance remain a source of instability.

Leptokurtosis. The frequency of disruptive market events involving the financial system and affecting the real economy does not conform to a Gaussian (the classic “bell-shaped” curve) statistical probability distribution. Instead, statistical patterns of deviation manifest “leptokurtosis”; events of intermediate deviation occur less frequently than would be predicted by a random distribution while both smaller and much more extreme deviations occur more often. Instead of the “100 year flood” occurring about once per century, it recurs virtually each decade.

Problems with Financial System Due to Flaws in Monetary System

“too abrupt and too late”. A telltale pattern of distorted signals and prolonged latency of adjustment may lead to higher amplitude deviations than might otherwise occur. Each unexpected disruption, for example, the housing bubble of the early 2000's, the build-up of unsustainable sovereign debt burdens, is years in the making, with warning signs that flash long before complacency abruptly turns to panic.

Discretionary monetary policy. The governing committees of government central banks, exercising discretionary judgment, undertake to influence economic conditions by modulating the supply and cost of reserves available to the banking system. The formulation of such discretionary monetary policies involves marshaling and analyzing voluminous data in an effort to divine the current actions and future intentions of the host of economic actors, such as households and firms, which make up the real economy.

Levers of control. Implementation of monetary policy then consists primarily of manipulating two lovers of control, the overall quantity of Base Money, and, the overnight lending rate at which banks may borrow Base Money to fund their immediate liquidity requirements. Prior to October 2008, the latter, known in the United States as the Fed Funds rate, had been the principal control measure for several decades. In 2008, the Fed Funds rate was ratcheted down to zero, rendering it as useless as a measure of control as “pushing on a string”. Since that time the Fed and multiple other central banks have resorted to non-standard and increasingly desperate expedients leading to unprecedented expansion of their balance sheets with assets of diminished quality and dramatically longer maturity.

Government central planning vs. distributed knowledge. This interposition of a bureaucracy between economic actors and the processes by which bank reserves are regulated fails to fully harness the vastness and nuance of distributed knowledge and the potential for collective wisdom. Legacy monetary arrangements instead risk the delay, errors of judgment and destructive feedback loops that inevitably attend government central planning.

Incremental adjustment alternating with bull-in-china-shop expedients. The rationale underlying discretionary monetary regimes is that expert guidance is required to foster smooth economic growth, anticipate consequences of current interventions and respond to disruptions that may occur from exogenous shocks. Discretionary management is portrayed as being like steering a super-tanker, requiring continual attention and occasional small adjustments, avoiding the need for sharper turns that may require leagues of leeway. The reality is that smooth policy projections and plans go out the window when financial markets, predictably yet unexpectedly, come off the rails, giving rise to sharp reversals or even novel experimental expedients. Instead of a monetary regime serving as an anchor, a Cartesian origin from which all other adjustments may be reckoned, discretionary adjustment becomes not only the origin of distortions that result in economic disruption but may also delay salutary adjustments needed for recovery.

Obligatory financial intermediaries. Every government monetary authority, whether central bank or currency board, hosts and administers a type of settlement platform, itself a type of remote payments system, via which reserves of member banks held in the form of deposits with that monetary authority are electronically conveyed in account-to-account transfers. In the United States this system is known as FEDWIRE®. In no case, however, has such a system or even the electronic form of Base Money that circulates on it been made available for direct use by the general public. Payment by means of a bank wire, for example, though it may settle via a FEDWIRE® transfer, involves the obligatory participation of at least two financial intermediaries, the payer's bank and the recipient's bank, adding cost, delay, risk of error and even a modicum of financial risk. No existing remote payments system directly accessible by the general public enables transfers of the electronic form of Base Money—the substance of bank reserves—without the obligatory involvement of one or more financial intermediaries.

Two types of Base Money. Reserves of banks held in electronic form as deposits with a government Monetary Authority comprise the major component of the monetary base (or “Base Money”)—the direct Monetary Liabilities of that Monetary Authority. The other component of Base Money issued by government Monetary Authorities consists of paper cash and coins.

Hand-to-hand form of Base Money too cumbersome to modulate credit conditions. Without exception, the only form of Base Money that has ever been made available for direct ownership or use by the general public has been hand-to-hand money, i.e., paper cash and coins. The inconveniences associated with the use of hand-to-hand money, particularly the attendant inability to directly spend and receive it via remote payment systems, has always served as a deterrent against the general public routinely drawing or restoring cash—the only form of bank reserves directly accessible to them—from or to the banking system in a volume or fashion that would modulate credit conditions.

Assets held against Monetary Liabilities. Government Monetary Authorities are, without exception, organized as banks, whether in accordance with a Central Bank or Currency Board model. As such they back their Monetary Liabilities with assets that can be classified as reserves or investments. Reserves consist of foreign currency holding including gold and SDR's. In contrast to reserves, which traditionally bear no interest and may, as in the case of gold, incur custodial costs, investments are remunerative financial instruments—securities or direct loans. Such financial instruments inevitably carry credit risk, the risk that the obligor fails to pay on time or in full. They are also subject to:
Interest rate risk—the inverse relationship between the market value of a debt instrument and prevailing interest rates,
Market risk—the risk that during intervals of market upheaval and disruption there may be no bidders for even a sound security except at ruinous fire sale prices, and,
Currency risk—risk arising from any mismatch between the currency denomination of assets vs. the currency denomination of liabilities and a change in the relative exchange rates adverse to relative valuation of assets.

Technical insolvency of Monetary Authority. These risks arising from holding financial instruments as assets against their Monetary Liabilities place each and every existing government Monetary Authority at risk of technical insolvency in the event of adverse market events such as sharp rise in interest rates.

Finality of settlement. The assurance of finality of settlement for settlement platforms provided by government Monetary Authorities derives from government guarantee. The need for a guarantee stems from their practice of allowing credit. For example, FEDWIRE® allows its participant banks to commit “daylight overdrafts”, transfers in which the transferred amount exceeds the actual balance of the paying account at the time of transfer. Under normal circumstances, by the end of the operational day, overdraft positions have been made up by incoming transfers such as the net final position of the participating bank is a non-negative balance. Extending such a guarantee relies on the credit and taxing authority of the state enabling it to act as a guarantor. Continuing with the example, if a bank in an overdraft position were to fail intra-day, the Fed must stand prepared to serve as a Lender of Last Resort, supplying funds to prevent a cascading sequence of defaults due to banks relying on incoming transfers to fund transfers in which they are the payer.

Monetary Policy and its goals. The concept of, the very term, “monetary policy” implies discretionary goals of an economic nature. With fiat money as issued by government central banks, exemplary goals include stability of the purchasing power of money. In the United States the Fed also has a mandate to foster full employment. Empirical observation would suggest that pursuit of any economic goal via monetary policies results in an asymmetric ratcheting process favoring stimulus and lower interest rates leading to accumulations of debt that eventually result in loss of control, risking monetary and economic collapse.

Problems with Government Fiscal Sustainability

Unsustainable fiscal/debt trajectory. The BIS, in its 82^{nd} Annual Report released June 2012 paints a bleak picture of “vicious cycles” involving the interplay of “unsustainable fiscal trajectory and deteriorating creditworthiness” of governments around the world with “overburdened central banks . . . pushed to maintain extraordinarily low interest rates to case the strain on fiscal authorities”. These “interacting weaknesses . . . continue to amplify each other”, “accelerating fiscal decay”, the resulting “fiscal maelstrom” making it imperative that “governments . . . put fiscal trajectories on a sustainable path”. A central bank is traditionally thought to exercise a restraining influence on governments, a sort of moral suasion, warning of the dire consequences of fiscal profligacy. In reality, however, government central banks ultimately yield to pressure to assist governments, to the limit of their powers, to find a market for their debt instruments. Instead of any ability to exercise a restraining influence, central banks end up implementing policies that, in the words of the BIS, “weaken incentives . . . for fiscal authorities to limit their borrowing requirements.”

Sovereign borrowing costs not sensitive to fiscal sustainability or currency risk. In the 1990's, the term “bond vigilantes” evoked the concept of market forces driving up interest rates on the sovereign debt instruments of governments that deviated from sound fiscal policies. To the extent this was ever true, so-called bond vigilantes have become impotent to impose fiscal discipline in a world awash in force fed liquidity resulting in a dearth of investment vehicles offering a positive real return.

Existing restraints ineffective. Systems/mechanisms currently exist to foster fiscal sustainability of government finance and expenditure, but they are not effective. In the United States, the Congressional Budget Office (“CBO”) is tasked to generate financial projections based on current law. Because such a basis is often recognized as fictional, the CBO also generates an “alternative fiscal scenario”, which despite also embodying unrealistically optimistic assumptions projects unsustainable debt trajectory. The International Monetary Fund (“IMF”) likewise generates extensive staff reports advising fiscal prudence and may seek to impose austerity programs on aid recipients. None of this seems to have any influence on actions of legislators. In nearly every nation, the electorate rejects austerity and clamors for the magic of increased government spending and a larger money supply. The actual actions of elected and appointed officials appear to be based on hope that if they can kick the can down the road until at least the end of their tenure, the future may sort out its own problems due to growth and robust demand. The imperative of winning election and re-election supersedes any possible agenda involving anything more than lip service to fiscal prudence.

Exacerbation of moral hazard. While it is widely accepted that the possibility of a bailout weakens the salutary restraining influence on banks that the prospect of bankruptcy and liquidation might otherwise exert, a similar effect operates with respect to national finance. Provision of liquidity to sovereign debtors by government central banks and related organization such as the IMF by means of monetizing any credible reservoir of credit not yet tapped out reduces the potential for money, as a scarce good, to act as an external constraint.

### Impaired Channels of Adjustment

Information value of relative exchange rates. Relative exchange rates for national currencies should provide timely and useful information enabling corrective policy or market driven adjustments. As things stand, however, all nations debase their currencies more or less in synchrony, all undertaking through competitive devaluation to avoid having a relatively stronger currency that might impair competitive advantage in export markets.

Information value of gold price. Supply and demand for gold is currently distorted with the result that the gold price is not very useful as an indicator for monetary or fiscal policies. This is partly due to the sequestration of over half of all gold ever mined in official holdings. This factor affords government central banks and international monetary agencies ability to overwhelm other sources of supply and demand by releasing or standing ready to release hundreds of tons into relatively thin physical markets. In addition to supply distortions, demand is diminished because of a paucity of financial intermediation and instruments involving gold debt. This is due to gold's current position as a commodity bought and sold with money; other than firms directly involved with gold production or manufacture no other economic actors have gold-linked cash flows that would support issuance and service, for example, of corporate bonds payable in gold. As things stand, gold prices often reflect investment positions defended by financial resources such that raising the ante of leverage in the form of conventional money balances and obligations plays a much greater role than offtake of actual physical gold. While the market making members of the London Bullion Market Association clear a daily volume of trades valued in the billions of dollars, settlement typically is a matter of moving a few bullion bars back or forth between the allocated stacks of a handful of gold banks.

Latency of credit quality ratings. While credit rating agencies such as Moody's, Fitch and Standard & Poor's provide ratings based on sophisticated data-driven analysis, rating changes tend to exhibit latency—closing the barn door after the horse is gone—that diminishes their value as a restraining influence on formation of government fiscal policy.

Discretion short circuits adjustment. The ability and inclination of government Monetary Authorities to influence (drive down) interest rates and to assure a ready market for government securities tends to short circuit the likelihood that deviation from sustainable fiscal policies and practices would lead to a timely rise in sovereign borrowing costs-feedback signaling the need for a restoration of prudence and restraint. As noted June 2012 by the Bank of International Settlements, “Ultimately, there is even the risk that prolonged monetary easing delays balance sheet repair and the return to a self-sustaining recovery through a number of channels. First, prolonged unusually accommodative monetary conditions mask underlying balance sheet problems and reduce incentives to address them head-on. Necessary fiscal consolidation and structural reform to restore fiscal sustainability could be delayed . . . . All this could perpetuate weak balance sheets and lead to a misallocation of credit.”

Problems with Existing Alternatives to Central Banks

### Government Currency Board

Hostage to policies of anchor Currency. A government currency board is constituted to maintain a hard exchange rate peg to and assured convertibility into a designated Outside Money, or anchor Currency. While this reduces or eliminates the ability of such a Monetary Authority to manipulate interest rates or monetize the debts of its host government, it leaves such a Currency completely hostage to the discretionary monetary policies of the central bank that issues the anchor Currency.

Limited circulation. In existing practice, Currencies issued by a government currency board have limited to no circulation outside of their domestic economy. No mechanism currently exists that might enable a currency board-issued Currency to rival the international circulation of its anchor Currency.

Revocation and repudiation. The most fundamental weakness of the gold standard was that it could be and was abrogated, repudiated and abandoned when governments found its restraints inconvenient. The same problem exists with government currency boards. While the architects of the Argentine currency board made every effort at its formation in 1991 to establish robust institutional safeguards to forestall relapse into hyperinflation, the realities of politics are such that it is impossible to bind a successor regime to inconvenient obligations. In 2001, Argentina repealed their “Convertibility Law”, redefined the Argentine peso with 40% devaluation and forcible conversion of both foreign debts and domestic privately held dollar deposits into devalued pesos.

### Privately Issued Alternative Currency

Real Money. While there are numerous systems, conventional and alternative, for remote payments, most circulate Broad Money obligations of existing government issued Currencies. PAYPAL® for example is a widely used alternative but it is used to convey liabilities denominated in USD, EUR, GBP etc. and payable with conventional bank deposits. All government issued Currencies of course are examples of Real Money as defined below but all remote payment systems that circulate existing forms of Real Money involve the Broad Money form during some or every phase of a transfer transaction. A few systems, however, undertake to issue their own distinct alternative Currency. Recent examples of privately issued alternative Currencies include LINDEN Dollars, FACEBOOK® Credits and BITCOIN. No existing or previously disclosed scheme for privately issued alternative Currency, however, has undertaken or proposed to issue a Currency that would meet the offered definition of Real Money. In particular, none have embodied characteristics that might cause banks to embrace them, holding reserve balances of them underlying deposits denominated and payable in them.

Problems with Existing Payment Systems

People impelled to use banks. The reasons people hold money in banks or bank-like institutions that hold money on account are: a) security, relative to holding large quantities of paper cash, b) interest income, again relative to holdings of paper cash, and, c) access to remote payment systems. Of these, access to remote payment systems is the primary factor. Bank involvement in remote payment systems impels greater usage of banks than would otherwise obtain. Loaning money to a bank (or money market fund, or brokerage offering checking/ACH services), however, carries with it exposure to the risk of non-repayment even though the ubiquity of deposit insurance that socializes this risk reduces public awareness of or concern regarding such risk.

Payment systems impelled to use banks. All existing remote payments services accessible by the general public that circulate Real Money are administered by banks or banking networks or are themselves reliant on remote payment systems administered by banks. Consumers pay credit card bills by check or ACH transfers. Credit card merchants receive payment in the form of deposits into their bank account. Even the inconvenient and expensive money services businesses such as check cashing services or traditional money transmitters on which the unbanked have little recourse but to rely are themselves wholly reliant on banks or networks of banks for clearing and settlement.

Intermediary costs and risk. The obligatory involvement of one or more financial intermediaries in all existing remote payment systems that circulate Real Money introduces additional latency, middleman costs and even the risk of intermediary default.

Bank involvement in payments systems amplifies supply of money and credit. The fact that existing remote payment systems entail the obligatory use of financial intermediaries causes more money to be loaned to them, i.e., deposited, than would otherwise obtain and leads to a larger and more volatile Broad Money supply due to the money multiplier effect intrinsic to banking and financial intermediation in general.

Broad money supply escapes control. While government Monetary Authorities conventionally implement measures to regulate the supply and cost of reserves to the banking system, the evolution of financial intermediation giving rise to a wide range of “shadow banking” roles and entities leads to substantial expansion of near-moneys that effectively act as Broad Money. This growth, along with a similarly amplified decrease in provision of liquidity during contractions, exacerbates the amplitude of credit cycles. The scope and complexity of measures that would regulate this money multiplier effect may at best entail a significant learning curve on the part of regulators and at worst may engender new and deleterious unanticipated consequences.

Settlement latency and velocity of money. Longer latency of settlement diminishes the velocity of money and therefore requires a greater money supply to generate equivalent GDP.

Payer default. Payments conducted via draft instruments with delayed settlement such as checks and ACH transfers, are subject to reversal due to insufficient funds on the part of the payer. A bounced check is a familiar example.

Payment reversal due to payer reneging and seeking involuntary refund. Payments conducted via credit card or credit card intermediaries such as Paypal® may be reversed by the payer even though the merchant recipient has accepted payment in good faith and performed all obligations. This is particularly problematic for sellers of digital content or electronic goods that may be delivered and or consumed online.

Problems with payments that draft. All payments that involve a draft, that is which pull payment from a payer account, including credit and debit cards, check and ACH draft, require the obligatory involvement of financial intermediaries, almost always including payer's bank and recipient's bank, adding cost, delay and even a modicum of financial risk. Furthermore, the Payer does not provide authorization directly to the system but rather to Recipient, entrusting recipient with data that if improperly safeguarded would allow an unknown third party to pose as Payer. This latter anachronism results in ever increasing fraud losses estimated in the billions of dollars per annum. On top of this, in such systems, investigation of fraud is severely hampered because interactions with centralized information systems are performed by the recipient or the recipient's financial institution. In instances of illicit activity, such as fraudulent payment using stolen credit card data, forensic data that could be captured if the Payer directly interacted with central system is not captured at all or is captured on systems of individual financial institutions that have no ability or inclination to make it available for more systematic routine analysis. A single criminal making fraudulent payments via multiple stolen credit card accounts would not even be recognized as all being the same phantom “payer”.

Problems with payment systems that “push” payments. Bank wires. The processing of bank wires commonly involves a bank employee transcribing and uploading the payer's wire instruction introducing delay and the risk of error. While a domestic bank wire may result in available funds for the recipient in a manner of minutes, delays are very common. With international bank wires, the situation is worse, with delays often ranging from several days to several weeks, depending partly on how backward the banking infrastructure is at either source or destination country. Upon inquiry, banks typically offer only opaque uninformative excuses for the cause of such delays. Bank wires are also subject to substantial fees, commonly affecting payer and recipient.

Traditional money transmitting services. FIG. 14 demonstrates the host of financial intermediaries involved with conventional money transmission protocols. With multiple intermediaries the cost structure passed on to the customer entails minimum transaction fees high enough to make such systems uneconomical for small value transfers. The transmission process is also inflexible, essentially bundling two exchanges to the actual transfer of value from payer to recipient. The first exchange consists of the payer exchanging cash for a promise to pay. The second exchange is the recipient exchanging the promise to pay for cash. If the cash paid in is a different Currency than the cash paid out, as with international remittances, there is also an obligatory exchange rate spread, adding to the overall transaction cost. Such systems are also inflexible with regard to distribution at the recipient end; whatever quantity is remitted is paid out in its entirety to the designated recipient.

Systems that “fund a payment” by means other than cash. The transaction model of payment systems such as PAYPAL® entail the concept of “funding a payment” by means of a transfer conducted via another payment system, most commonly via credit card or ACH draft. In essence, PAYPAL® itself acts as a credit card merchant, bearing the costs of credit card interchange fees. As a consequence, the fees charged for a payment through such a system cannot be lower than their own cost of funding the payment. Moreover, the risk of payment repudiation due to fraud or other failure resulting in reversal of the funding payment is passed along to the ultimate merchant recipient. In 2006-2007, the only interval for which EBAY® provided disclosure that would enable calculation of fraud losses borne by their customers, such losses exceeded 5% per annum, adding substantially to the net cost of accepting payment by such means.

Lack of global reach and exclusion of the unbanked. Credit cards and debit cards tied to deposit accounts are in use around the world. The high risk, however, of fraud loss associated with certain jurisdictions such as Nigeria, Vietnam or Belarus may cause domestic processors in the United States to reject payments based on the location of the would-be payer. Moreover, people lacking established credit, or who elect for religious or other reasons to eschew use of credit-based systems, or the growing cohort both domestically and worldwide of the unbanked—collectively the majority of the world's population—are effectively excluded from being customers of online venders that only accept such payment methods.

Traceability. All government issued Currencies circulate to significant degree in the form of bearer instruments—physical tokens such as paper cash and coins—that are anonymous and untraceable. Hand-to-hand physical transfer of possession of such tokens is the preferred mode of payment for a wide range of criminal activity.

Counterfeiting. Sophisticated technologies are employed by governments or their contractors for the manufacture of paper cash to foil counterfeiting. It is impossible, however, to perfectly limit access to these same technologies and in fact government intelligence agencies are alleged to have abetted in diversion of technologies to enable counterfeiting the paper money of not only foreign countries but even in some cases of their own.

Money Laundering. Despite extensive, complex, costly and intrusive laws and regulations that criminalize and are intended to thwart money laundering, such abuses remain rampant with existing financial institutions and payment systems. In 2012 alone, long-standing patterns of purposeful institutional policies and practices to circumvent anti-money laundering prohibitions have been identified involving multiple international banks. While laws and regulations governing money services businesses seek to detect and prevent such flows at the “placement” stage by addressing the practice of “structuring”, effective prevention of structuring involving conventional money such as US dollars that circulate in paper form is impossible with existing systems. While a single vender may maintain systems to detect structuring exploits that involve multiple of their agents, existing systems cannot detect a network of smurfs who divide up their transactions into amounts below reporting thresholds and spread them among agents of multiple competing venders.

### Impediments and Risks of Monetary Reform

Connectedness and interdependence. Recent advances in evolutionary theory elucidate a bi-phasic, or punctuated, model observed in biological systems. For long intervals of relatively stable environmental conditions the dynamic of natural selection induces a more and more highly connected fitness landscape with established hierarchies that serve as a sort of barrier to entry to novel species. Conditions then change however so that the very connectedness that served to make a system resilient serves to make it brittle; instead of local extinctions widespread de-populations occur as food chains are disrupted. A strikingly similar dynamic is observed in the economic sphere. The existing monetary system has fostered a global financial system of unprecedented connectedness with too-big-to-fail (or, in current IMF and BIS parlance, “Systemically Important”) banks and “too large to bail” national polities at the top of this hierarchy. As a result, the butterfly effect of a restructuring of sovereign debt in one of the peripheral European economies may roll channels of transmission varying from direct losses on the part of institutions responsible for honoring credit default swaps to close-the-barn-door reactions of credit rating agencies to downgrade similar sovereigns and the banks holding their debt instruments. The greatest threat of this connectedness is that a debt crisis leading to a banking collapse would result in a breakdown of existing remote payment systems. Every attempt is made to secure the integrity of clearing and settlement systems by means of contractual safeguards but the continued reality is that default may cascade through such a system, effectively locking it until restructurings can release claims to in-process receivables. A catastrophic example would be breakdown of the Euro-zone Target 2 system if any southern tier European state were forced into disorderly default. Civilized society largely depends on the division and specialization of labor made possible by remote payment systems and their breakdown would endanger the material welfare of mankind.

Consensus. Any change of existing monetary arrangements, just as with government fiscal policies and actions, is impossible in the absence of consensus among the political elites or majorities that exercise power. Such consensus for institutional change rarely if ever emerges except in the clamorous aftermath of crisis and when it does occur reflects the interests of controlling elites mingled with political compromises and the imperative to transition as smoothly as possible from existing systems, broken and flawed as they may be. While achieving consensus at a national level is difficult, it would be further complicated at the global level by valid concerns that dominant politics, those already endowed with “exorbitant privilege”, introduce regimes that reinforce existing asymmetries of power and economic advantage.

Forcible replacement. The introduction of the euro exemplified the forcible replacement of existing Currencies with a government mandated successor. While ratified by national legislatures, the replacement of Deutsch Marks, French Francs etc. with euro was involuntary for the millions of people who opposed the change. The process of substitution, in effect a massive currency exchange operation, was also implemented in a fashion that was a significant cost center for banks. Unlike a voluntary Currency exchange transaction, in which providers of exchange may capture profits from the spread between the prices at which they offer to buy and sell, banks were mandated to swap both physical token money (paper notes, coin) and the denomination of deposits at a fixed exchange rate, without fee revenue or other compensation. Historically, introduction of new money, especially when an inferior money is forced upon populations as a means of financing an insolvent state, is accompanied by coercive force ranging from seizure of property to imposition of the death penalty for refusing to accept the new money at its official valuation as defined by price controls or official exchange rates.

Global Currency. The global financial crisis that became evident in 2008 has led to proposals from sources ranging from the Vatican to the IMF for a global Currency, issued by a global central bank. Each such proposal is premised on conventional thinking that would lead to a global Currency with all the embedded contradictions and flaws of existing Currencies, more or less like the US dollar or the euro, except on a global scale. All embed an unquestioned premise that greater government regulation is essential to financial stability and economic growth. They advocate money creation backed by a broader range of collateral, including instruments of inferior credit quality. Each envisions a lender of last resort prepared to create unlimited liquidity as the countercyclical response to financial crises. The Vatican proposal, echoing contemporary European initiatives for banking and political union, calls for a “world political Authority”.

### SUMMARY OF INVENTION

Embodiments of the present invention may provide systems and methods for administering a private sector Monetary Authority. The potential macro-economic and political impact/benefits of the system comprise an integral component system in that the directly administered elements of the system are designed to exert such impact via the described emergence scenario. The overall system, while designed with such an ultimately beneficial path in view, cannot prevent nearer term financial and economic disruptions due to embedded flaws and contradictions of existing systems nor can it forestall transitional disruptions. The system, both directly administered elements and the broader system of ramifications, is designed in anticipation of transitional effects that would inevitably result from its emergence and takes advantage of them to facilitate commercial success and emergence.

### Stability of Financial System in General

Inherently unstable. Embodiments of the present invention enable one or more alternative Currencies, each with a money supply that is automatically self-adjusting. This self-adjusting money supply, combined with systems serving as efficient channels of adjustment, may attenuate financial fluctuations and the economic disruptions that result from them. The result may be a financial system that, while comprised of institutions such as banks engaged in business that is inherently risky, does not generate instability. Emergence of the present invention may also serve to foster sustainable government fiscal policies and practices.

Leptokurtosis. The leptokurtosis currently evident in the statistical distribution of economic deviations may diminish because the disclosed mechanisms of automatic self-adjustment are more exquisitely incremental, with less latency and less subject to manipulations that tend to short circuit channels of adjustment.

Financial system stability stemming from monetary system “too abrupt and too late”. The mechanism of automatic self-adjustment of both Base and Broad Money supply comprising the heart of the present invention is continuous, forestalling excesses in a “stitch in time saves nine” fashion.

Discretionary monetary policy. The present invention eschews any concept of a monetary policy. It rests instead on simple, unambiguous contracts (see “Issuer's Declaration of Liability” below) reinforced by automated transparency measures that would alert the world to any deviation from their terms.

Levers of control. The system of the present invention enables direct End User access to Base Money that is electronic and transferable via a remote payments system affording immediate settlement. This direct access to such a medium of exchange and to efficient mechanisms for making and receiving transfers of it may facilitate, for the first time ever, the free and convenient flow of reserves into or out of the banking/financial system in such a way as to modulate their supply and cost without the middleman inefficiencies of an interposed bureaucracy. Any End User electing to eschew the financial risks of holding deposits in the banking system at prevailing interest rates in favor of directly holding Base Money balances may do so without sacrificing the convenience of access to efficient remote payments capabilities. Instead of a central committee with two large levers, one controlling the size of the monetary base, the other the overnight lending rate for bank reserves, every economic actor using the System may exercise a continuous and exquisitely incremental influence over both Base Money supply and interest rates with their every decision as to whether to hold Base Money, securities or the deposits of a financial institution.

Government central planning vs. distributed knowledge. Instead of a committee of experts undertaking to marshal and interpret voluminous data regarding the current actions and future intentions of economic actors, the mass of such economic actors, each likely acting in his own self-interest, directly meter the money supply, harnessing distributed knowledge and wielding it in accordance with a collective wisdom.

Incremental adjustment alternating with bull-in-china-shop expedients. After emergence of the disclosed model, the threshold at which any individual economic actor might decide to eschew loaning money to the financial system at then-prevailing interest rates in favor of holding it in Base Money form is likely to vary in fine increments. Each and every decision to avoid financial exposure reduces the potential leveraging of money stocks. With the present invention, the moment a few individuals or firms that are more risk averse see future excesses brewing they can start to exert a restraining influence that exerts an incremental upward nudge on interest rates.

Obligatory financial intermediaries. The disclosed system enables individuals and firms to make or receive remote payments without any interposed financial intermediary, reducing the costs, delays and settlement risk of payment.

Two types of Base Money. Base Money issued by means of the disclosed system exists and circulates only in electronic form, by book entries in an accounting system. Emergence of the disclosed system would not be expected to impact the decision-making processes of existing Monetary Authorities with regard to their continued issuance of hand-to-hand anonymous tokens.

Hand-to-hand form of Base Money too cumbersome to modulate credit conditions. The disclosed system gives the general public direct access to Base Money and a remote payments capability that rivals or exceeds the transaction efficiencies of bank mediated payments. This facilitates routine inflows or outflows to or from the banking system in a volume that could modulate credit conditions.

Assets held against Monetary Liabilities. The issuer of the gold-linked Currency of the present system is not organized as a bank and its Monetary Liabilities are neither deposits nor banknotes. The gold-linked Monetary Liabilities issue in the form of Bailment and as such cannot be used to fund an investment portfolio. The underlying physical assets are held in Bailment. Embodiments of the present system that involve gold-linked Currency require a continuous 100% reserve of physical gold rather than any instrument of investment. Each gram of physical gold content that backs a gram of the gold-linked Currency is immune to deviation from being a gram, regardless of interest rates or the other variables that influence the market value of financial instruments.

Technical insolvency of Monetary Authority. Embodiments of the present system that involve gold-linked or other physical commodity-linked Currencies eliminate the risk of technical insolvency due to balance sheet fluctuations of their Base Money Issuer.

Finality of settlement. The disclosed System may achieve finality of settlement without resort to any lender of last resort guarantee by means of technical elements bolstered by contractual provisions. The only conditionality of settlement may be to enable a mechanism for addressing transfers in execution of instructions that are later determined to have been erroneous or unauthorized. This mechanism may balance the possibility of recovery against the imperative of not damaging an innocent third party.

Monetary Policy and its goals. The present system eschews any monetary policy but rather is governed by unambiguous contracts defining the Monetary Liabilities of any Issuer. Rather than targeting any particular economic outcome, the system defines a Cartesian origin—a fixed monetary relationship that may serve as a reference point and anchor for all other monetary and financial arrangements. This Cartesian origin is the requirement of a 100% reserve of physical gold backing any and all of the gold linked Currency in circulation such that every gram of the Currency is backed by at least a gram (fine content) of gold bullion. In addition, all other Currencies the Base Moneys of which circulate within the system must either be commodity-based with a 100% reserve of the matching physical commodity or established and operated in accordance with a Currency Board model. Just as price stability was never a goal of the classical gold standard—yet sustained price stability over a period of centuries resulted—the disclosed system does not presume to target price stability or any other economic outcome.

Problems with Government Fiscal Sustainability

Unsustainable fiscal/debt trajectory. Unlike existing arrangements in which monetary policies may be manipulated to accommodate and postpone the consequences of unsustainable debt trajectories by monetizing debt and artificially suppressing interest rates, the gold-linked (and other commodity-linked) Base Money in the disclosed system is anchored to physical constraints. This assurance of scarcity, combined with more efficient channels of adjustment, may serve as an external constraint enabling fiduciary prudence by assuring that new money cannot and will not be created to support timely debt service when due.

Currency risk, fiscal sustainability and sovereign borrowing costs. The disclosed combination of a fixed reference point and efficient channels of adjustment with decreased latency may enable more immediate, incremental and higher fidelity correlation of sovereign borrowing costs to fiscal sustainability and currency risk.

Existing restraints ineffective. Unlike existing monetary arrangements, the lack of discretionary wiggle room of the disclosed system, combined with automated real-time transparency measures and other governance safeguards enable it to fulfill its role as an external benchmark that cannot be gamed to obfuscate the signaling function of market prices such as exchange rates. In other words, while existing monetary arrangements may mask unsound conditions since the only points of reference are the equally unsound arrangements in other countries, the disclosed system provides a foreign Currency without nationality relative to which the exchange value of existing Currencies may decline.

Exacerbation of moral hazard. Unlike existing monetary arrangements that can be stoked to manufacture liquidity by seemingly endless monetization of debts, thereby deferring adverse consequences of excess, the certainty that the supply of the disclosed gold-linked Currency is limited to the quantity of gold bullion bailed into the underlying reserve raises the bar defining any potential lender of last resort and may therefore inhibit profligate risk taking.

### Impaired Channels of Adjustment

Information value of relative exchange rates—The disclosed system, with its linkage of Base Moneys to physical commodities instead of the imperatives of sovereign finance, may emerge as the primary external benchmark relative to which decline in the exchange value of government issued Currencies may be evident.

Information value of gold price. Mobilization of the value of gold in the form of money may enable a dramatic increase in demand, especially as financial intermediation becomes possible due to growth and stabilization of cash flows involving the gold-linked Currency. Growth of the disclosed system leads to offtake and retention of physical gold and may, with emergence, tend to unwind the current sequestration of gold. This dishoarding, while accompanied by a rising gold price may also result in the gold price becoming harder to manipulate. Moreover, with emergence, a decoupling of the exchange rate for the gold-linked Currency from the price of physical gold may develop such that the premium of the exchange rate over the price of the underlying gold, known as agio, gives rise to additional ramifications that both drive additional demand and serve to enhance the information value of both the gold-linked Currency's exchange rate and the agio itself.

Latency of credit quality ratings. Improved fidelity of the exchange rate channel may lead to improved ability to factor Currency risk into credit quality ratings. Moreover, by enabling End Users to directly control the supply and cost of money available to financial intermediaries, interest rates may become so responsive as to render credit quality ratings a superfluous anachronism.

Discretion short circuits adjustment. The disclosed system prevents discretionary manipulation of the Currencies organic to it and may facilitate market based discovery of natural (market-clearing) interest rates.

### Existing Alternatives to Central Banks

### Government Currency Board

Hostage to policies of anchor Currency. Embodiments of the disclosed system provide for two categories of Currency. The core Currencies are commodity-linked and -backed with a 100% reserve of the physical commodity. A secondary category is comprised of Base Moneys issued in accordance with a conventional currency board model. The commodity-linked/backed Currencies are not subject to discretionary influences.

Limited circulation. An existing government currency board or private financial institution undertaking to issue Base Money as provided for with the disclosed system may manifest advantages that enable international circulation that may attain a magnitude rivaling that of its anchor Currency. These advantages may derive from: a) growth of the international user base of the system, and, b) transaction related benefits such as non-repudiation, immediate settlement, high security and low transaction cost.

Revocation and repudiation. In all embodiments of the disclosed system that entail private firms acting as Issuer(s), the(ir) respective Declaration(s) of Liability defining the Base Money serve as binding contracts. Any party damaged by a breach of these contractual obligations could bring an action seeking recovery. Even in the case of a sovereign currency board electing to matriculate to the system as an Issuer, the System Provider may better secure continued performance by means of legal instruments such as a contract governing the right to circulate.

### Privately Issued Alternative Currency

Real Money. Each Currency the Base Money of which is issued and circulates by means of the disclosed system may meet the offered definition of Real Money.

Problems with Existing Payment Systems

People impelled to use banks. The disclosed system enables access to an efficient remote payment system separate from and completely independent of banks, circulating Base Money that in embodiments involving commodity-linked Currency embodies no element of credit or credit risk.

Payment systems impelled to use banks. The payment process of the disclosed system is completely independent and self-contained and does not involve or rely on any financial intermediary.

Intermediary costs and risk. The disclosed system requires no financial intermediary in the payment process and may therefore offer immediate settlement, elimination of credit risk and cash-like finality of transfers.

Bank involvement in payments systems amplifies supply of money and credit. The disclosed system enables both greater disintermediation and efficiencies of payment which combined reduce overall need for money and excesses in the overall supply of money and credit.

Broad money supply escapes control. The disclosed system enables the broad public to incrementally withdraw from exposure to financial system whether formal banking sector or “shadow banking” intermediaries, thereby attenuating or preventing excessive expansion of Broad Money and credit that sets the stage for subsequent busts.

Settlement latency and velocity of money. The disclosed system enables immediate settlement of transfers, supporting greater velocity of money. In addition, the system may include an account maintenance fee that may exert a “demurrage” effect, further stimulating velocity enabling a smaller stock of money to support a greater level of economic activity.

Payer default. The disclosed system eliminates the risk of payment reversal due to insufficient funds on the part of the payer.

Payment reversal due to payer reneging and seeking involuntary refund. The disclosed system discourages payment reversal by payers who would seek to renege on a payment that had been properly authorized and was not erroneous.

Problems with payments that “pull” or draft. Payment with the disclosed system does not involve a draft but rather is of a “push” type in which the payer provides authorization of payment instructions directly to the settlement platform. There is therefore no need in the disclosed system for a payer to entrust a payment recipient with data that needs to be safeguarded to prevent subsequent unauthorized payments. Direct provision of authorization for payer to system eliminates the costs delays and risks of financial intermediaries and enables the system access to a wealth of forensic data that would aid in investigation of identity theft, fraud or exploits attempting unauthorized access whether successful or unsuccessful.

Payment systems that “push” payments. In the disclosed system, unlike bank wires or a WESTERN UNION®-like system, there is no need for payment instructions to be transcribed and/or uploaded by a financial intermediary to the ultimate transfer/settlement platform; the payer directly provides payment instructions and authorization, reducing delays and risks of error. With international remittances, the system affords greater flexibility than traditional money transmitting services, unbundling the actual transfer of value from possible exchanges on the part of payer or recipient. This enables extreme low direct costs supporting economical usage for small value payments. This flexibility of the disclosed system also affords a recipient a range of options with regard to value received. Instead of payout of the entire transferred value in local Currency, the recipient may elect to retain some or all of the received amount on account, and/or to transfer portions when convenient to subsequent recipients who similarly are not obliged to exchange for local currency. Moreover, unlike PAYPAL® or other “push” systems that “fund a payment”, the system's lack of exposure to the costs and reputability of other payment systems enables lower fees and an assurance of non-repudiation mitigating or eliminating involuntary losses due respectively to fraud or payer default for recipients that receive payment in good faith and perform their obligations.

Global reach and the unbanked. The disclosed system embodies no element of credit due to automated enforcement of a strict debit rule. Since it is immune to payer default it can be made available to people around the world regardless of their credit history or lack of established credit, including the unbanked.

Traceability. The disclosed system maintains permanent records of every transfer enabling the entire lineage of every particle of value in circulation to be traced back to its initial issuance.

Counterfeiting. With the disclosed system a combination of internal controls, combined with a governance model based on separation of roles reinforced by automated transparency measures prevent issuance or distribution of Monetary Liabilities exceeding the underlying assets.

Money laundering. The disclosed system, unlike any existing conventional payment system, maintains a consolidated central database enabling superior detection, interdiction and reporting of abuses such money laundering. Criminal efforts, for example, to structure cash exchanges so as to facilitate their placement in the financial system would be thwarted by the system's superior ability to detect aggregation of small value flows or other criminal patterns involving a network clandestinely operating under unified or coordinated control.

### Impediments and Risks of Monetary Reform

Connectedness and interdependence. The present system is uniquely independent of all existing financial institutions including government central banks. While currency exchange—the primary channel by which usage of the present system would disseminate—would be disrupted in event of disruption of existing payments infrastructure, the system and its functionality would remain intact. Moreover, even in a setting of complete breakdown of all other remote payment systems, the disclosed system could still grow and scale—perhaps serving as a safety net—by means of large existing holders of gold bullion, including sovereign holders, matriculating to the system and bailing in their gold.

Consensus. Benefits of the present invention do not require consensus or even widespread understanding or embrace of the underlying theory on the part of users to achieve its benefits. The benefits are proportionate to embrace and usage and may manifest as an emergent phenomenon. As such, the benefits may be more likely to become manifest after an inflection point marking a phase change where the attainment of a critical mass of usage ignites network effects that broaden and accelerate the macroeconomic and political impact of the system.

Forcible replacement. The disclosed alternative Currencies are not intended to supersede or replace any existing government issued Currency but rather to circulate as alternatives, playing a complementary role. Rather than being introduced by a process that entails banks being compelled to substitute a newly issued replacement for legacy Currency without compensation for their expenses, the disclosed Currencies are introduced by voluntary Currency exchange. This Currency exchange process may serve as a source of both one-time windfall and continuing profits for banks at substantially lower risk than their conventional credit/risk and liquidity/maturity transformation activities entail.

Global Currency. The disclosed Currencies, particularly the one with Base Money 100% backed by gold, are intended to serve as alternative global Currencies to the extent they are voluntarily embraced by economic actors worldwide. The characteristics summarized here and detailed below may enable the disclosed system, following emergence, to exert a salutary “invisible hand” influence similar to what was observed at the dawn of the 20th century with the classical international gold standard, but without the weaknesses due to the gold standard's susceptibility to rule bending and eventual abrogation.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. While these drawings only show a particular embodiment, for that embodiment they are roughly drawn to scale.

FIG. 1 shows an exemplary technical system architecture for provision and administration of a private sector Monetary Authority in a networked computing environment.

FIGS. 2A and 2B show an exemplary organizational structure for one possible embodiment.

FIG. 3 shows a system whereby an Applicant may progress to become an Account Owner.

FIG. 4 shows a system of Spends and the environment within which they may be conducted.

FIG. 5 shows a system of classification for Persons and subsets of Persons as addressed in the disclosed system.

FIGS. 6A and 6B show a method the logic of which the system applies in processing a Spend.

FIG. 7 shows a system for Bailment of assets and Issuance of Base Money.

FIG. 8 shows a system for Redemption of Base Money and release of assets.

FIG. 9 shows a system for an Exchange Provide to sell Base Money to its customers.

FIG. 10 shows a system for an Exchange Provide to buy Base Money from its customers.

FIG. 11 shows a system for funding a BMP Account via a BMP Account Funding Spend.

FIG. 12 shows a system for a participating Depository Institution to provide Currency exchange via BMP Accounts.

FIG. 13 shows a system for organizing the Account Module of an Exchange Provider.

FIG. 14 shows a legacy system used by conventional money transmitting businesses.

### DETAILED DESCRIPTION OF THE EMBODIMENTS

Overview of system components. Embodiments of the present invention may include systems: a) designed to serve as a private sector Monetary Authority, and, b) for administering a community of participants, matriculation to which is a prerequisite for access to the products and services of the private sector Monetary Authority.

Monetary Authority. Systems may be provided for enabling the combined activities of a System Provider and one or more Issuers to serve as a private sector Monetary Authority. As such, these systems transcend boundaries of conventional business model classification providing both the Base Moneys of distinct alternative Currencies and an alternative remote payments system via which they are issued and distributed, circulate, and may be redeemed and de-issued.

Base Money of Currencies. The Base Moneys that may be held and circulate within the system may be classified into core and secondary groups, further disclosed below. One such Base Money (in the core group) is linked to and backed by a 100% reserve of gold and constitutes an obligatory element for the system to achieve the full range of beneficial macroeconomic effects disclosed herein.

Issuance/De-Issuance. Systems provide for the Issuance and De-Issuance of Base Moneys via the Settlement Platform on which they circulate.

### Payment System

Settlement Platform. The Remote Payments System may include a Settlement Platform with an Account mechanism that enables participating Members to hold quantities of the Base Moneys in circulation and to make and receive Spends. The Settlement Platform also may provide a mechanism and interface enabling Members designated as Issuers to Issue and De-Issue these Base Moneys. With such a system the only means of obtaining a Balance of one of the Base Moneys in circulation is by receiving a Spend from an Account belonging to a Member who or that already owns some.

Accounts. In preferred embodiments in which the System Provider is a corporate entity separate and distinct from any entity serving as Issuer, particularly with regard to their balance sheets, no Balance held in any Account on the Settlement Platform, with the exception of Accounts belonging to the System Provider itself, would constitute either a liability or an asset of the System provider. Likewise, in such embodiments, an Issuer would neither have nor need to have knowledge of the End Users holding quantities of its Monetary Liabilities as their asset, contractually delegating all responsibility for administering and keeping track of all such Accounts and their contents to the System Provider. Such an arrangement, unprecedented with regard to the settlement platforms maintained by any government Monetary Authority, may warrant usage of the descriptive term “wallet” as an alternative to “account”.

An instructive analogy to further illustrate the novelty of this arrangement involves the bearer tokens—paper cash and coins—which constitute embodiments of a component of the Monetary Liabilities issued by government Monetary Authorities. The Monetary Liability embodied in these bearer tokens is tracked in aggregate on the balance sheet of the government Monetary Authority liable for their issuance although details regarding each end user holding such tokens, who may hold them as assets in an actual physical wallet, are neither known nor knowable since such bearer tokens circulate anonymously. The Issuers of Monetary Liabilities that circulate via the disclosed system, like the government issuers of cash and coin, have no particular knowledge of who holds them at any given time or what they do with them. Unlike the anonymous bearer media issued by governments however, every particle of value circulating via the disclosed system, every transfer, every Owner, may be tracked and traceable all the way back to its initial issuance.

Direct access. Unlike the electronic form of Base Moneys issued by government Monetary Authorities, which only banks may own/hold, the electronic Base Money circulating within this system may be owned—by being held on account—by participating members of the general public. Unlike the settlement platforms operated by government Monetary Authorities to enable account-to-account transfers of their electronic Base Moneys, which only banks may use, this system enables direct access and usage by participating members of the general public to make and receive such transfers.

Requirements never contemplated by government. Extension of direct Settlement Platform access privileges to End Users may introduce system requirements that government Monetary Authorities have never needed to address or even contemplate. Direct system participation and usage by a broad segment of the general public may increase the risk of the Settlement Platform being abused for purposes of money laundering, terrorist finance or other criminal or illicit activity. System requirements may therefore include systems for: generalized customer-initiated matriculation, a Customer Identification Program, Customer Due Diligence, transaction monitoring and investigation and reporting of suspicious activities. Systems may be provided to support much higher transaction volumes than would be processed on systems with a narrower range of participants. Systems may place greater emphasis on provision of commercially attractive products and services that a wide range of economic actors, including financial institutions, voluntarily embrace without the coercive advantage conferred on government Monetary Authorities by virtue of the legal tender status accorded to their Monetary Liabilities.

Private sector. While one or more Issuers on this system may be government entities, the System Provider may be a private sector firm.

Bound by contract. While no government Monetary Authority has ever been held liable for damages consequent to its abrogation, repudiation and/or unilaterally imposed redefinition of its Monetary Obligations, private sector entities conducting operations via the disclosed system may be effectively bound by contract.

No government guarantee. While the Monetary Obligations of government Monetary Authorities are backed by implicit or explicit government guarantees, the value of Monetary Obligations issued via and circulating within the present system may rest only on the assets held against them secured by a well-conceived institutional governance model. In the case of the disclosed gold-linked Base Money, value may be secured by continuous maintenance of a 100% reserve of physical gold held in suitable custodial arrangements.

Community of participants. In contrast to the compartmentalization of legacy monetary and payment system arrangements, corresponding to politically defined boundaries, the disclosed system may support a more global community of participants. While potentially global, the system may be closed in the sense that all participants are subject to systematically implemented conditions and requirements for matriculation to and continued participation in the system.

### Transaction and Media of Exchange

Closed system. The disclosed systems are closed in the sense that Base Moneys Issued and circulating within the System cannot leave and Outside Money cannot enter. The only media of exchange that circulate within the payments system constitute the Base Money of distinct privately-issued Currencies issued exclusively into and by means of the system and circulate only within the System. The only way to obtain a quantity of any of the Base Moneys that circulate in this System may be by receiving (a) Spend(s) from another Account that already contains a quantity of that Base Money. Moreover, Outside Money, value in any form, preferably can neither be sent into or withdrawn from the System nor circulate therein.

### Spend.

Defined. A Spend is an Account-to-Account transfer, effected by book entry crediting the Account of the payer and debiting the Account(s) of the recipient(s) in an atomic transaction in fulfillment of a Spend Instruction that has been authorized in advance by an authorized User on the paying Account with said authorization communicated directly and securely from payer to System and Authenticated by the System.

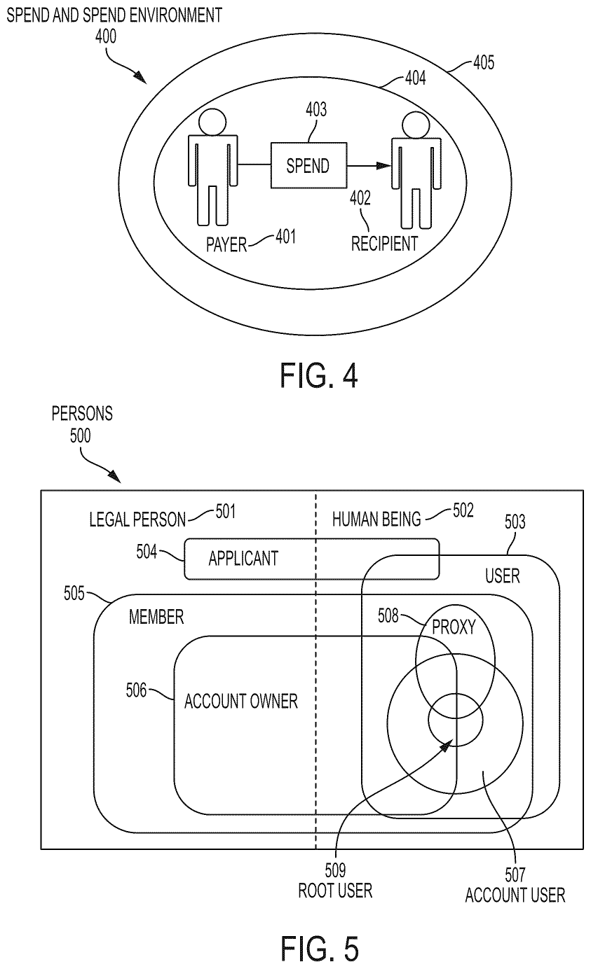

FIG. 4 shows a system 400 by which Payer 401 may transfer value directly to Recipient 402, with no intermediary, via Spend 403. Spend 403 occurs within the closed environment of Settlement Platform 404, access to which in turn is restricted to a closed community of credentialed participants 405.

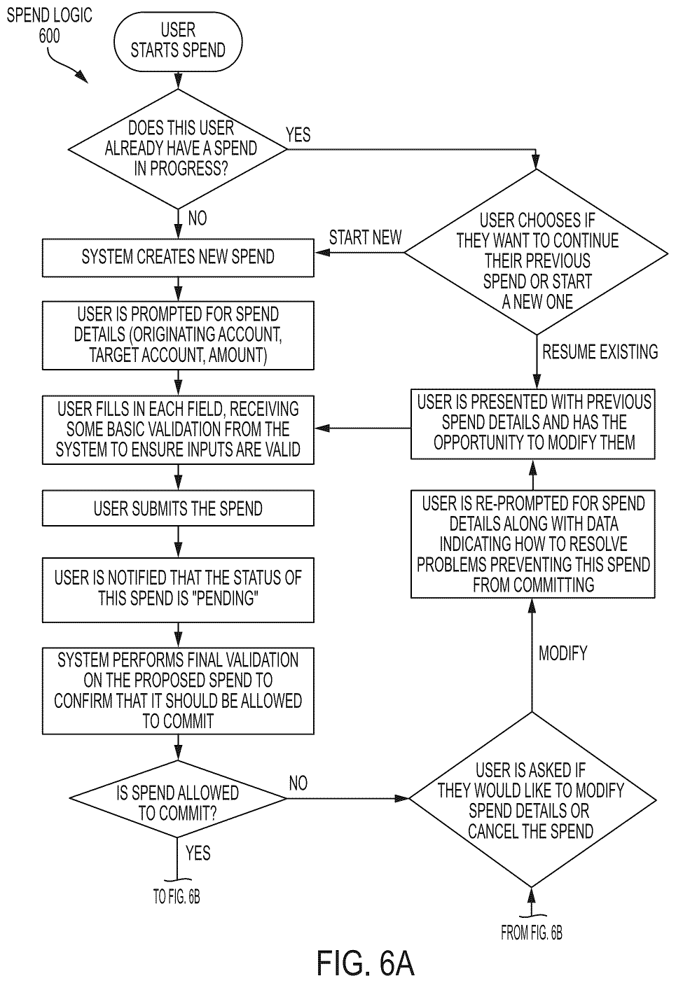

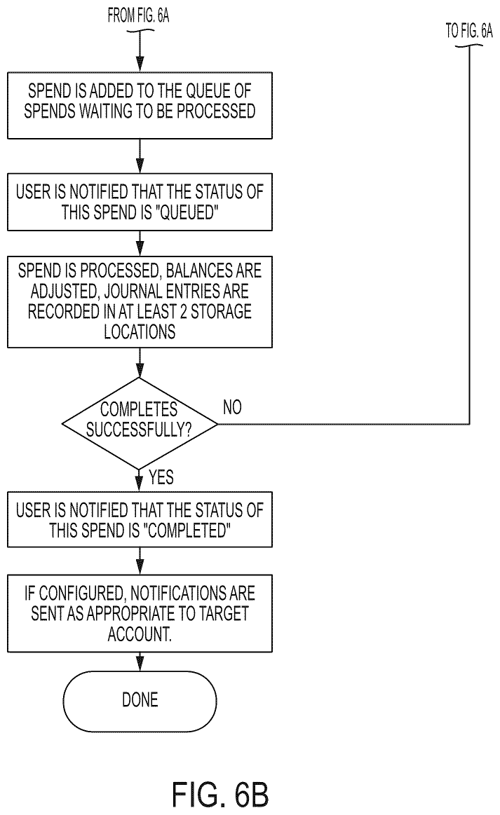

FIGS. 6A and 6B show a system 600 for an exemplary logical flow for the processing of a Spend, following system authentication that the User authorizing the Spend instruction has requisite privileges. In addition, prior to reaching the stage of Spend object creation, the system may perform basic pre-screening with client side apps analyzing the potential acceptability of a nascent Spend Instruction in the light of data-such as Available Balance-forward cached to the client computing device.

Spend Instruction. Systems may be provided for specifying and submitting Spend Instructions.

Interfaces for specifying and submitting Spend Instructions. The system may support specification and submission of a Spend Instruction from an interface provided to an already logged-in User, in which case presentation and validation of Log-in credentials would have already been performed and may not need to be repeated. Systems may also support processes of fewer steps such as commencement of a session via submission of a partially or fully specified Spend Instruction in the URL (“Uniform Resource Locator”) of an http (“HyperText Transfer Protocol”) GET request. The system may also support recovery of a Spend Instruction for which the specification process had been commenced but not completed and resumption of the specification, authorization and submission process.

### Parameter Specification

Numeraire. The Numeraire for specifying the amount of a Spend in a Spend Instruction may differ from that of the Settlement Currency to be conveyed via the Spend. For example, a Spend Instruction may specify “Pay [recipient Account] 10.25 USD worth of [the gold-linked Currency]. When such a differing Numeraire is used in a Spend Instruction, the system may then present the prospective payer with a preview displaying the actual quantity of the Settlement Currency, rendered in the unit of Account native to that Currency, to be conveyed. This Spend Preview may also display the Reference Exchange Rate used to perform the calculation.

### Scope of Supported Numeraires.

Quotes readily available. Systems may support use of any numeraire for which exchange rates are readily available, such as the units of account for conventional national Currencies.

Readily calculated. Systems may support use of any numeraire which can be readily calculated from prices or exchange rates that are directly available. Examples of such numeraires may be baskets or indexed combinations of conventional Currencies and/or prices of specified commodities and/or indexes that are themselves calculated from such combinations.

Reference Exchange Rate. The System may maintain Reference Exchange Rates to support use of differing Numeraires as a convenience for Members, without warranty as to their correlation to any actual currency exchange rates available in exchange markets. The System, via these Reference Exchange Rates, may also enable display of an approximate equivalent value of balances rendered using Numeraires that differ from that of the Settlement Currency.

Source. Systems for setting Reference Exchange Rates may preferably draw exchange rate data from one or more Exchange Providers or Depository Institutions that actually make a market for currency exchange involving Currencies the Base Moneys of which circulate within the system. In the event of non-uniformity of sampled exchange rates the system may apply statistical analytical processes to exclude possibly erroneous quotes and/or to smooth, average, or weight exchange rates quotations determined likely to be valid.

Modulation from commodity price to Currency exchange rate. The Method for maintaining reference exchange rates may, with emergence of the system to large scale usage, modulate away from reliance on prices of the physical commodities underlying the system-circulated Currencies toward use of actual market-provided exchange rates for the Currencies themselves.

Authorization. Systems may be provided to authenticate that a Spend Instruction is Authorized by a participant with requisite Privileges.

Testing of conformity. Systems may be provided to determine if Spend Instruction conforms to all relevant System rules before allowing its execution/settlement.

Immediate automated settlement. Systems may be provided to afford immediate automated settlement of Spends 24/7/365, unlike transfers conducted via settlement platforms of government Monetary Authorities that limit hours of operation.

### Reporting

Counterparty identification. Systems may be provided to display the Account Module Name, as provided below, to the counterparty of a Spend.

State and notification. Systems may be provided to display report of the status and outcome of a Spend Instruction that was submitted for execution.

Historic. Systems may be provided to display reports of Spends made or received to Users authorized to receive the specific information.

Conditional finality, Systems may afford conditional finality of settlement of Spends while offering mechanism for potentially mitigating loss due to Erroneous or Unauthorized transfers provided such mitigation does not damage any innocent third party.

RTGS. A Spend is a “push” type payment mechanism that may execute in accordance with a Real Time Gross Settlement (RTGS) protocol.

Strict Debit. A Spend, with the single exception of an Issuance Spend, conforms to a Strict Debit Rule, enforcing that a Spend Instruction specifying a Spend Amount that is greater than the Available Balance in the paying Account will not be executed, thereby precluding payment failure or reversal due to an insufficient amount of money in the payer's Account.

Non-repudiation. Payment repudiation, an effort to seek reversal of a Spend because the payer has changed his mind, may be proscribed by contractual agreement. An Account Agreement, which must be accepted as a condition of Account creation, ownership or usage, may provide that an attempt on the part of a payer to repudiate a Spend that was neither Unauthorized nor Erroneous via the Disputed Spend mechanism (see below) may result in Account closure and expulsion from the System.

### Disputed Spend

### Contractual Elements.

Definition. Disputed Spends may be classified into two categories, Erroneous and Unauthorized.

System investigatory discretion. System may reserve full discretion to determine if a Disputed Spend claim is valid and what measures, if any, may be undertaken to mitigate payer loss.

Prohibition of wrongful profit. Actions of a recipient deemed as constituting an attempt to wrongfully profit from a Disputed Spend may be grounds for Account closure, expulsion from the System and/or legal action.

No warranty of recovery. System may disclaim any warranty that actions taken in response to a Disputed Spend claim will result in successful recovery and restoration of value to the payer.

No harm to innocent third party. System may decline to take actions to mitigate payer loss due a Disputed Spend that it deems may result in harm to an innocent third party. Such a party may be the primary or downstream recipient of an erroneous transfer or the unknowing downstream recipient of value diverted by an unauthorized (fraudulent) transfer.

### Technical Elements.

Claim and designation. System may provide interfaces enabling payer or recipient of a particular Spend to submit a Disputed Spend claim. System administrative or investigatory staff may also have interfaces facilitating designation of a Spend as Disputed including, in appropriate circumstances, subsequent or downstream Spends.

Hold. System may implement methods to place a Hold on direct or downstream recipient SubAccounts to stabilize value pursuant to a Disputed Spend investigation.

Assisted recipient return. Systems may be implemented to assist the direct or downstream recipient of a Disputed Spend with a convenient interface to facilitate a voluntary Spend of value back to the original payer in an amount automatically adjusted as to be net of any fees that may have subsequently diminished the corpus of the disputed value.

Administrative override Spend. Systems may be implemented to enable System Provider to initiate a Spend for the recovery and return of value from a direct or downstream recipient Account deemed to contain proceeds of an unauthorized or erroneous Spend. An administrative override Spend may also be performed by System Provider actions in connection with closing an Account.

### Variant Forms

SCI Spend. Systems may provide for SCI Spends.

Mass Spend. Systems may provide for Mass Spends.

Pre-authorized Spend. Systems may provide for pre-authorized Spends in which the Spend Instruction specifies conditions for non-immediate, that is, future execution. With such Spends, the Spend Instruction would specify the paying and recipient Account but may specify a range of options for other parameters such as but not limited to Spend Amount, time window of execution, whether to try again (along with when and how many times) if the Spend cannot be completed due to insufficient Balance in the paying Account at the time of attempted execution, and scope of authority for recipient in terms of specifying Spend Amount, memo, and timing of execution. The pre-authorized Spend Instruction process may also allow for amendment or cancellation of the instruction by the payer at any time prior to execution of the Spend.

Bill presentment. Systems may provide for a bill presentment process in which a prospective recipient may specify parameters for a Spend that the system then securely transmits to the prospective payer's computing device such a mobile phone enabling streamlined authorization that may entail as little as a single click signifying approval.

Issuance, Distribution, Redemption and De-Issuance Spends. See description below of Bailment/Issuance and Redemption/De-Issuance processes.

Account. The system provides for the creation, use and closing of Accounts that, with the sole exception of (a) Mint Account(s), are asset accounts comprised of one or more Currency-specific SubAccounts that may contain Balances of Base Money belonging to the Owner(s) of that Account.

Account creation and provisioning. Systems may be provided enabling Users to create and provision Accounts.

Jurisdictional granularity. The system may support jurisdictional granularity such that a Person may become a Member but may not be extended Permissions necessary to create, own or use any Account if, for example, they reside in a jurisdiction that does not permit use the system's payment capabilities.

### Properties

Unique identifier. Account number may be a System generated alphanumeric string used to uniquely identify an Account. The generation process may incorporate randomness which, combined with length and complexity, may reduce the risk that an error in specifying an Account, particularly in the specification of a Spend Instruction, might accidentally match any existing Account, possibly resulting in an Erroneous Spend. The leading Character of an Account Number may be P or B, identifying the Account as a Personal or Business Account. This prefix convention may reduce the risk of a fraudster successfully tricking a payer, for instance on a fake website into direct a Spend to a Personal Account.

Account Module Name. System may associate a User-submitted Account Module Name with an Account Module that may then be exposed to the counterparty of a Spend. This Account Name may be displayed to the prospective payer at the time a Spend Instruction is submitted and to both payer and payee in reports of previously settled Spends. Since it is displayed, the proposed Account Name may be reviewed during the initial Customer Service review of CDD to assure the selected label would not be damaging to the reputation of the System or indicative of possible criminal intent on the part of the Account User. A change of Account Name preferably prompts re-review.

In the System Provider review of the initial provisioning or subsequent amendment of an Account Module, the system may allow for default system approval of an Account Module Name that matches or only contains components of the Legal Name of an Owner of the Account Module. The system may, however, require administrative review and approval for an Account Module Name that does not match or only contain components of the Legal Name of an Owner of the Account Module.

Letter of Authorization. Systems may provide for use of a letter of authorization by which a Person grants authority to a Member who is a User to serve as Proxy for that Person. Systems may provide for generation of letters of authorization assuring explicit specification of all required parameters.

Subaccount. Accounts may contain one or more SubAccounts. A User on the Account with requisite Permissions may specify which Base Moneys the Account may contain, thereby specifying which SubAccounts are activated.

Hold. The system may provide for placing and removing a Hold on a SubAccount.

Account status. Systems may provide for assignment and modification of the status of an Account.

Blocked. A blocked Account may not receive Spends but Spends may be made from it.

Frozen. A frozen Account may not receive Spends nor may Spends be made from it except by System Provider performing an administrative override Spend.

Open by court order. An Account may be designated as open by court order. An example may be an Account that System Provider has determined should be closed due to suspicion of illicit activity but is left open for monitoring purposes pursuant to court order.

Closed. A closed Account may be blocked or frozen depending on whether closed voluntarily by a User acting on behalf the Account Owner(s) or by System Provider. Closed status may primarily determine how User options pertaining to that Account are displayed to the User. Account closure may not result in deletion of Account records.

### Base Money

Electronic book entry in accounting system. The Base Money(s) that are issued and circulate via the disclosed system exist(s) in the form of book entries in an accounting system administered by a System Provider.

Distinct Currencies. Each Base Money issued and circulating via the disclosed system is the Base Money of a distinct Currency rather than representing Broad Money denominated or payable in any existing government-issued Currency. Each Currency the Base Money of which is issued and circulates via the system may require a unique name and/or Currency code that serves to distinguish it from existing Currencies and may require protection as intellectual property after the fashion of a brand name.

Declaration of Liability. Each Base Money issued and circulating via the disclosed system constitutes the liability of a particular Issuer. The liability defining each such Base Money may be explicitly declared in a Declaration of Liability set forth by its respective Issuer.

Redemption and De-Issuance on demand. The Issuer of each Base Money issued and circulating via the disclosed system must stand ready to redeem and De-Issue any or all of it on demand, specifying this obligation and any conditions governing redemption in its declaration.

Issuance on demand. The Issuer of each Base Money issued and circulating via the disclosed system must stand ready to issue additional Base Money on demand, specifying this obligation and any conditions governing issuance in its declaration.

Core group. The Base Moneys issued and circulating via the disclosed system may be categorized into two groups. The core group may be of primary significance with respect to achieving the macroeconomic benefits of a self-adjusting money supply that, upon emergence, may serve as an external constraint enabling governments to adhere to sustainable fiscal policies. Each Currency in this core group mobilizes the value of a particular physical commodity. The primary and obligatory Currency in this group is linked to and backed by gold. Other Currencies in this core group may mobilize the value of other commodities such as silver, platinum, palladium, rhodium or titanium.

### Underlying Assets

100% reserve of the corresponding stored physical commodity. The only assets that may be held to back Base Moneys in the core group are 100% reserves of the corresponding stored physical commodity, eliminating all financial risks that attend to holding financial instruments as assets against Monetary Liabilities. In the case of bullion reserves, the 100% reserve is calculated on the basis of fine content such that, for example, 1000 grams of gold of 0.995 purity would count as 995 grams fine content.

Bailment. The precious metal bullion backing Base Moneys in the core group is held in Bailment for the sole benefit of Holders of that Base Money and may not be loaned, hypothecated or otherwise encumbered for any purpose.

Held in trust. The Bailee for commodities held as reserves backing Base Moneys in the core group may be a trust. This trust may be a special purpose trust.

Utilize existing institutional infrastructure. Arrangements for sourcing and storing the precious metal bullion reserves held as backing for the Base Moneys in the core group may take advantage of the pre-existing infrastructure of institutional arrangements established and used by international gold banks to support their bullion operations.

Bullion purity and fabrication standards. Conformity with existing widely accepted standards governing refinement, purity and fabrication of bullion bars, such as the good delivery standard administered by the London Bullion Market Association may be required for bullion reserves held as backing for the Base Moneys in the core group.

### Custodial Arrangements.

Allocated Storage. Bullion reserves held as backing for the Base Moneys in the core group must be held in Allocated Storage, titled to the designated Bailee as specified above.

Repositories. Precious metal bullion reserves held as backing for the Base Moneys in the core group may be stored in the repositories used by international gold banks and government central banks for storing their bullion. The dispersion of reserves across multiple repositories located in different jurisdictions may mitigate risk of loss due to compromise of any particular facility whether from physical disaster, criminal activity or political/military gambit.

Closed custodial loop. Bullion held as backing for the Base Moneys in the system must be sourced from and must remain in a closed custodial loop as used by international gold banks and government central banks to assure the continued integrity of their bullion holdings.

Nature of Monetary Liability. The Monetary Liabilities constituting the core group of Base Moneys in the system and deriving their value from assets held in Bailment are in the nature of a Bailment that, by virtue of crossing the balance sheet of the Issuer, may be rendered and expressed using numbers, thereby becoming fungible, divisible by means of arithmetic calculation and readily transferable by book entry in an accounting system.

Unit of account. The native unit of account for describing or specifying a quantity of any of the Currencies the Base Money of which is in this core group may be grams (and decimal fractions of grams). Alternatively, troy ounces (and decimal fraction) may also be used as a unit of account since there is a fixed standard arithmetic ratio between these two units in their conventional usage as units of weight, one troy ounce being equivalent to 31.1034768 grams. Usage of these terms as units of account for Monetary Liabilities may serve to highlight the 100% reserve requirement that dictates that for every gram of a bullion-linked Base Money in circulation in the system there must be at least one gram (fine content) of the corresponding bullion backing it.

Freedom from default risk. Base Moneys in the core group may derive a high degree of freedom from default risk from their requirement of a 100% reserve of the matching physical commodity along with safeguards to mitigate risks relating to the integrity and physical security of such reserves.

Secondary group. A secondary group of Currencies may play a complementary role facilitating the emergence and economic benefit of the primary gold-linked Currency of the core group. While sharing common mechanisms for Issuance, distribution, circulation and holding, Redemption and De-Issuance with the core group, Base Moneys in the secondary group differ in the nature of their liability, stemming from differences in the assets with which they are backed.

Currency board. Base Moneys within the secondary group may conform more closely to a standard currency board model in that they may: a) be backed in part or whole by financial instruments, and, b) may be anchored to existing major national Currencies. As with the core group, however, they differ markedly from the institutional model of traditional government currency boards with regard to their mode of circulation and their direct accessibility in electronic form by End Users.

Single anchor. A Base Money in the secondary group may be anchored to a single specified government issued Currency.

Index or basket. A Base Money in the secondary group may be anchored to a basket of two or more anchor Currencies or a calculated index combining various specified government issued Currencies and/or commodities in a fixed ratio of components.

Nature of the liability. Base Moneys of the secondary group are Monetary Liabilities denominated in a unit of account distinct to that Currency as declared by its Issuer.

Not a deposit-taking activity. Base Moneys of the secondary group, even if issued by a credit institution as set forth in Directive 2006/48/EC of the European Parliament, or a government currency board that may elect to matriculate to the system as an Issuer, may not be loaned into existence, that is, they may not be Issued as a granting of credit but rather must be Issued in exchange for funds received at par value as set forth in their respective Declaration.

Anchor and ratio. The Issuer of Base Money of the secondary group in its Declaration of Liability must specify the Outside Money(s) or other standard(s) of value to which its liabilities are anchored and the precise ratio or ratios to be maintained. For example, one Issuer may simply specify that it is obliged to redeem its Base Money on demand at a fixed ratio of one US dollar for one unit. A more complex example might be an Issuer specifying an obligation to maintain parity of its unit to the Special Drawing Right (SDR) defined by the International Monetary Fund and to perform its redemption obligations in one or more of the component Currencies at the exchange rate in effect as of the day of Redemption as published by the IMF.

### Underlying Assets.

Asset quality and liquidity. The assets that may be held against Base Moneys in the secondary group may include financial instruments including but not limited to government securities, bank deposits, futures contracts, commercial paper and collateralized repurchase agreements. The Issuer of Base Moneys in the secondary group may be bound by contract with the System Provider to publish in its Issuer's Declaration of Liability specific details regarding not only the categories of assets that may be held but also the maximum maturity for each asset type. The Issuer may be further bound by contract to provide advance notice to every holder of its Base Money of any prospective change in the asset classes to be held or their maximum maturity.

Commingling impermissible. Even if issued by a credit institution that is not a government currency board, Monetary Liabilities issued via the system as Base Money of a Currency in the secondary group must be backed by assets specifically earmarked and set aside for the sole purpose of backing such Monetary Liabilities.

Held in trust. In order to assure the assets backing Base Money of the secondary group are not encumbered by other liabilities of the entity serving as Issuer they may be held by and titled to a trust which may be a special purpose trust.

Issuance/De-Issuance. System may enable one or more Issuers to Issue and De-Issue Base Money in fulfillment of Open Market Operations initiated by a Primary Dealer.

Issuer. System may provide for one or more entities to be assigned capabilities and responsibilities to perform the Role of Issuer. The Issuer is responsible for the subsidiary Roles of Mint and Comptroller

Mint. The Person assigned the Mint Role exercises control over a Mint Account.

Delegation to a Mint Fiduciary. The Issuer may delegate performance of the Mint Role to a third party Mint Fiduciary. Such delegation may enhance system security and integrity through greater separation of Roles and/or may enhance system reputation if the Mint Fiduciary is widely recognized as highly reputable.

Comptroller. The Person assigned the Mint Role exercises control over a Comptroller Account.

Primary dealer. System may provide for one or more entities to be assigned capabilities and responsibilities to perform the Role of Primary Dealer.

Open Market Operations. System may provide for the conduct of Open Market Operations.

Core group. With the core group of Base Moneys, a Primary Dealer may initiate the process that culminates in Issuance of new Base Money by Bailing a bar or bars of bullion into the Allocated Storage arrangements maintained for the holding of reserves in conformity with specifications of the applicable Issuer's Declaration of Liability and business rules of the system. A Primary Dealer may initiate the process that culminates in De-Issuance ad release of specified bullion bar(s) by means of a Redemption Spend in conformity with the applicable Issuer's Declaration of Liability and business rules of the system.

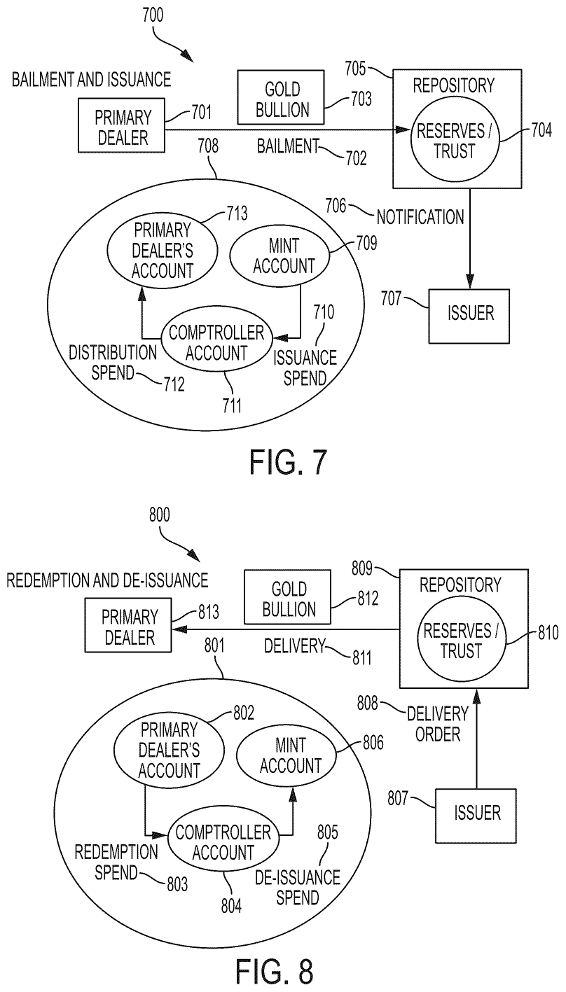

Bailment and Issuance process/saga. FIG. 7 shows a system 700 by which new quantities of the gold-linked Base Money may be created and distributed into circulation on/within the Settlement Platform. The process begins external to the Settlement Platform 708 when Primary Dealer 701 makes a Bailment 702 of gold bullion 703 to the allocated storage holdings 704 of the Trust which serve as reserves. Upon receipt of the bullion, the Repository 705 sends notification 706 to the Issuer 707. Assets having been secured, issuance of new Base Money of the gold-linked Monetary Liabilities may proceed within the closed universe of Settlement Platform 708. On the authority of Issuer 707. An Issuance Spend 710 is made from Mint Account 709 to Comptroller Account 711. A Distribution Spend 712 is then made the Account 713 of the Primary Dealer 701 that had Bailed in bullion 703.

Redemption and De-Issuance process/saga. FIG. 8 shows system 800 by which quantities of the gold-linked Base Money are removed from circulation and extinguished and gold bullion released from reserves. The process begins within the closed universe of Settlement Platform 801 with a Redemption Spend 803 from the Account 802 of Primary Dealer 813 to Comptroller Account 804. De-issuance Spend 805 is then made from Comptroller Account 804 to Mint Account 806 resulting in a decrease in the amount of the gold-linked Base Money in circulation. Monetary Liabilities having decreased, a corresponding quantity of gold bullion may be released from reserves. Upon confirming receipt of De-Issuance Spend 805, Issuer 807 sends Delivery Order 808 to Repository 809 specifying a particular bar or bars of gold bullion 812 to release from the holdings of Trust 810. In certain preferred embodiments Delivery Order 808 must also be authorized by Escrow Agent (not shown). Upon successful authentication of Delivery Order 808, Repository 809 makes Delivery 811 of gold bullion 812 in accordance with instructions of Primary Dealer 813.

### Internal Controls.

Reserves Store. To forestall errors in the process of Redemption and De-Issuance of Base Moneys in the core group, the system may implement a Reserves Store.

### Platform—Technical Considerations

### Technical Implementation

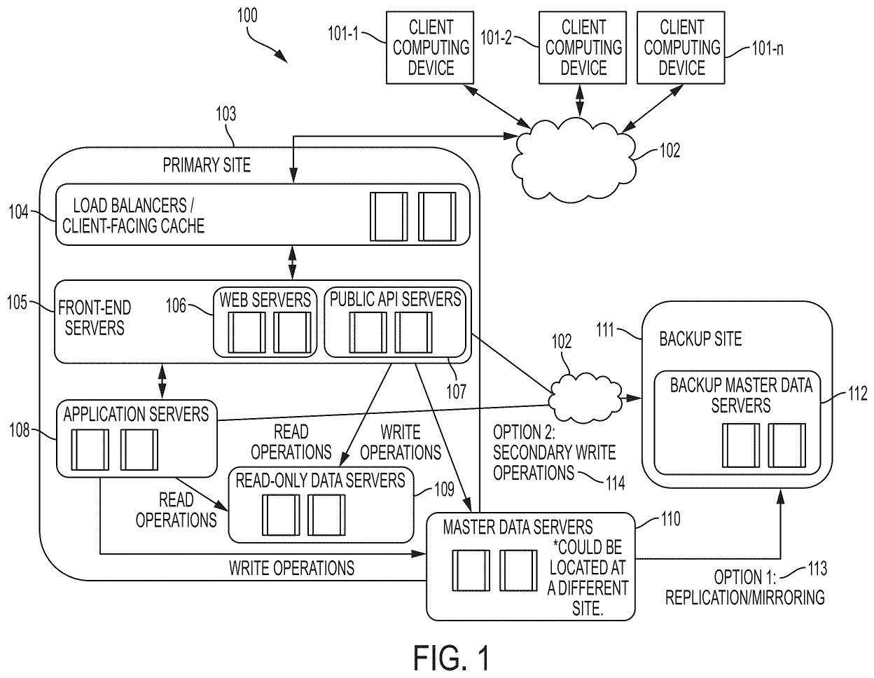

Logical architecture. FIG. 1 shows an exemplary system logical architecture according to one embodiment. In this exemplary implementation, principles of Command Query Responsibility Separation (CQRS) are utilized to maximize system performance by directing all Read Operations to servers containing forward-cached data, thereby reducing the load on the Master Data Servers and Backup Master Data Servers to which Write Operations are directed, enabling their maximum availability for Write Operations (which tend to be inherently resource intensive). In this exemplary implementation, system 100 includes one or more server/computing devices at Primary Site 103, operatively coupled over network 102 to one or more Client Computing Devices 101 (e.g., 101-1 through 101-n) and to one or more databases maintained on one or more server/computing devices comprising Master Data Servers 110, which could located either at Primary Site 103 or at a separate site (not shown), and Backup Master Data Servers 112 at one or more Backup Sites 111. Within the Primary Site 103, Front-end Servers 105, such as Web Servers 106 and Public API Servers 107, direct Read Operations to Read-only Data Servers 109. Application Servers 108 similarly direct Read Operations to Read-only Data Servers 109. Write Operations, in contrast, are directed to Master Data Servers and are backed up to Backup Master Database Servers. Two options for such backup are depicted. In the first Option 113, data written to Master Data Servers is replicated and/or mirrored to Backup Master Data Servers 112. With alternative Option 114, concurrent with Write Operations to Master Data Servers, data is also directly written to Backup Master Data Servers via Secondary Write Operations. Network 102 represents, for example, any combination of the Internet, local area network(s) such as an intranet, wide area network(s), and/or so on. Such networking environments are commonplace in offices, enterprise-wide computer networks, etc. Client computing devices 101, which may include at least one processor, represent a set of arbitrary computing devices executing application(s) that send data inputs to and/or receive data outputs from one or more server/computing devices deployed as Load Balancers/Client-facing cache 104. Such Client Computing devices include, for example, one or more of desktop computers, laptops, mobile computing devices (e.g., smart phones, tablet computers, or PDAs), server computers, and/or so on. In this implementation, Master and/or Backup Data Servers publish data written to them to Read-only Data Servers which may in turn refresh data cached on more forward server devices or even in cache on Client Computing Devices such as, for example, secure caching capabilities provided with certain modern Web browsers or smart phones. Embodiments of the present invention may be web-based.

Command Query Responsibility Segregation (CQRS). The technical implementation of certain embodiments may exploit the efficiencies and enhanced scalability afforded by CQRS design patterns.

Sagas. In order to minimize resource constraints such as prolonged table locking inherent to commitment of an atomic transaction in a relational database, systems may make use of sagas—a software design strategy to automate management of a potentially long running business process, possibly containing multiple distinct transactions that must be coordinated and that must ultimately settle and persist (or roll back) overall as an atomic transaction but must correctly handle more than one message that may arrive asynchronously, in any order, and that may also receive duplicate messages that should not be acted upon. An example might be encapsulation of the Issuance process enforcing an internal control to prevent duplicate logging of a bailed bullion bar or Issuance of Monetary Liabilities in excess of the assets bailed into reserves.

Event sourcing. Systems may apply event sourcing to trigger state changes and the persistence mechanism for sagas.

Forward caching. System may economize on database queries by change event driven updates of forward cached data.

Persistence solutions. Systems may preserve data using a range of persistence solutions.

Relational database. Systems may incorporate relational databases as a persistence solution for data requiring referential integrity such as a ledger of account balances.

Document database. Systems may incorporate document databases or other semi-structured data management and persistence solutions enabling greater flexibility in handling data less amenable to a pre-determined schema. An example may be systems for Membership data enabling easier maintenance of a software application if new extensions are added, such as integration of biometric authentication technologies that may emerge in the future.

Main memory database system. Systems may make use of main memory database systems in implementations that assure high availability through replication and automated failover. Such systems may for example enable persistence of a partially completed form enabling a User to pick up where they left off if interrupted while completing an application or configuring a complex instruction.

Multi-platform client support. Systems may be implemented in a fashion to facilitate porting to multiple diverse client side computing platforms including but not limited to web browsers on personal, laptop or tablet computers and smart phones with capability to run “apps”.

### Data Integrity and Robustness

### Economic Community

Closed system of credentialed participants. Participation in the System may be limited to Persons that/who have undergone a rigorous Membership enrollment process involving successful completion of a Customer Identification Program (CIP). The CIP may be similar to what is typically required to open a bank account. Upon approval, Members residing in jurisdictions where participation is permissible may apply to participate as Account Owner and/or Account User in the payments system, a process involving rigorous Customer Due Diligence (CDD).

FIG. 3 shows an exemplary progression of status from Applicant 301 to Member 302 and to Account Owner 303. Customer Identification 304 review and approval is required for Applicant 301 to become Member 302. Applicant 301 must also accept terms of Membership Agreement 306 and, in certain embodiments, Referral Agreement 307 governing a Referral Incentive Program for existing Members who/that refer new prospective Members. For Member 302 to become an Account Owner 303, additional Due Diligence 305 must be successfully completed and Member 302, directly or via a Proxy authorized to act on prospective Account Owner's behalf, must accept terms of Account Agreement 308. An Account User (not shown), acting on authority of prospective Account Owner 303, must also agree to Issuer's Declaration of Liability 309 offered by the Issuer of any Base Money that Account Owner 303 intends to Hold.

No need for established/approved credit. Since a Spend is implemented as to be Immune to the risk of payer default the system may not need to impose any credit-related prerequisite for Membership or Account Ownership. The system may therefore be made available to Persons without established credit and/or who may be unbanked.

Identified counterparty, Systems may assure that any prospective transactional counterparty has successfully undergone identification and due diligence meeting a specified standard.

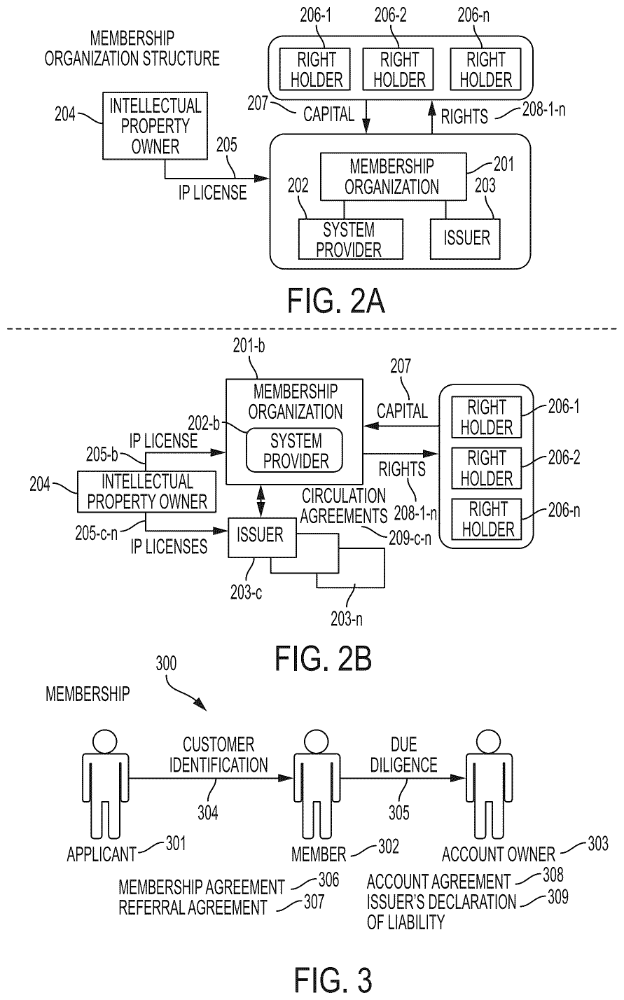

Organizational forms. FIG. 2a shows an exemplary organization of entities for one possible embodiment in which a Membership Organization 201 is the licensee under IP License 205 for intellectual property owned by separate and independent Intellectual Property Owner 204. In this particular arrangement Membership Organization 201 is the parent company of both System Provider 202 and Issuer 203 and IP License 205 grants use of intellectual property enabling performance of both Roles. Right Holders 206-1-n provide capital 207 to Membership Organization 201 and are respectively granted Rights 208-1-n.

FIG. 2b shows an alternative exemplary organization of entities for one possible embodiment in which Issuers 203-c-n are separate and independent of Membership Organization 201-b (although Members) and operate under IP Licenses 205-c-n. In this arrangement IP License 205-b provides for performance of the System Provider Role while IP Licenses 205-c-n each enable conduct of the Issuer Role. System Provider 202-b may be one and the same as, or organized as a division of Membership Organization 201-b. Circulation Agreements 209-c-n are contracts between System Provider 202-b and each Issuer 203-c-n governing arrangements whereby Base Moneys may be issued and circulate via the Settlement Platform provided and administered by System Provider 202-b. In this arrangement, Capital 207 provided by Right Holders 206-1-n is provided to Membership Organization 201-b. Issuers 203-c-n, in contrast, must provide for their own capitalization.

Membership Organization. The Membership Organization and the entity acting as System Provider, which may be one and the same, may eschew a conventional equity ownership model as exists for example with a company that issues stock and is owned by shareholders.

Roles. Embodiments of the present invention may include Roles. Separation of roles may enable superior governance, protecting System integrity. This may be useful regarding elimination of the risk of malfeasance, error or external coercion leading to deviation from defined Currency obligations. Distinct Roles may also mirror patterns empirically discovered in decades and centuries of the practices of money and banking as conducive to efficiency and orderly markets.

### Institutional

Core. Core Roles may be those required for Issuance, initial Distribution, Redemption and De-Issuance of the Base Moneys that circulate within the System.

System Provider. System Provider may provide systems enabling all other participants to interact with the system in accordance with their Roles.

Obligations. All obligations of the System Provider may be explicitly memorialized in contracts between System Provider and other Members and, in certain preferred embodiments, with the IP Owner.

Administers Membership systems. System Provider responsibilities may include providing a means for the enrollment, credentialing and maintenance of Members.

Administers Settlement Platform. System Provider responsibilities may include providing a means for creation and provisioning of Accounts for eligible Members and enabling the conduct of Spends.

Distributes revenue. System Provider responsibilities may include collection and distribution of revenues.

Issuer. The system requires at least one Issuer but may support multiple Issuers. Issuers may be private sector firms, government bodies, or both. In preferred embodiments the System Provider does not serve as Issuer although both may share a common parent. An Issuer may be a completely separate firm from that of the System Provider.

Distinct systems. While an Issuer relies on System Provider to provide for interactions with the Settlement Platform on which the Issuer's Monetary Liabilities are issued and circulate, the system may provide separate systems whereby the Issuer may administer information systems and operations involving assets that serve to back such liabilities.

Obligations. All obligations of an Issuer may be explicitly memorialized in contracts that may include but would not be limited to an Issuer's Declaration of Liability that precludes formulation or implementation of a discretionary monetary policy.

Redemption on demand. The system may require each Issuer to contractually bind itself, and assure performance of the obligation, to Redeem their respective Base Moneys on demand pursuant to the terms of their Declaration of Liability. Conditions of Redemption may be imposed such as restricting exercise of the right of Redemption to Primary Dealers.

Issuance on demand. The system may require each Issuer to contractually bind itself, and assure performance of the obligation, to Issue their respective Base Moneys on demand pursuant to the terms of their Declaration of Liability. Conditions of Issuance may be imposed such as restricting the right to initiate Open Market Operations to Primary Dealers.

Automated transparency. Systems may be provided for publication of data regarding quantity of the various Base Moneys in circulation as well as quantity and composition of reserves and statistics regarding System usage, all serving as transparency measures to reinforce governance safeguards in certain embodiments.

Escrow Agent. Issuers may be contractually bound and systems provided to assure that the authorization of a third party escrow agent must be obtained as a condition of release of any assets held as backing against their Monetary Liabilities.

Repository/custodian. A major element in selecting gold as the underlying asset for the primary Base Money may be that an extensive well-conceived and cost effective infrastructure exists, supporting wholesale physical gold market operations and custodial arrangements. The physical reserves held against the Base Moneys in the core group may be in the form of Good Delivery bullion bars of the corresponding precious metal in Allocated Storage at one of the treasury grade Repositories normally used by gold banks.

Primary Dealer. The System Provider may impose the requirement that a Primary Dealer must be a Member and Financial Institution, offering exchange services as either an Exchange provider or a Depository Institution.

Credentialing process. The System Provider may impose a credentialing process to assure that any prospective Primary Dealer has the resources and capability to honor all obligations attendant to that Role.

### Obligations.

Market Maker. A Primary Dealer must make an orderly market for exchange for one or more of the Base Moneys that circulate within the system.

Motivation to initiate OMO. In the disclosed System, Primary Dealers initiate open market operations (“OMO”) for their own business purposes, particularly to support their own ability to make, as required, an orderly market for currency exchange that meets their agreed liquidity parameters.

Logic for restricting OMO. The disclosed Primary Dealer arrangement may offer additional benefits relative to a less restricted system such as one that would afford all or a broader cohort of End Users permissions to Bail and Redeem.

Reduced risk of faulty assets. Restricting the right to initiate OMO to credentialed Primary Dealers reduces the risk that the Issuer issues Monetary Liabilities backed by insufficient or faulty assets. A Primary Dealer may also be bound by contract to carry insurance against the risk that, despite systematic safeguards to prevent faulty assets such as adulterated bullion bars from entering the system, certain assets are subsequently discovered to be faulty,

Core group. The extensive credentialing process for Primary Dealers helps to assure that any bullion Bailed into reserves is genuine and that in the unlikely event a bar or bars are subsequently discovered to be fake or adulterated the Primary Dealer has the financial strength to obtain and provide good delivery bullion to replace it.

Secondary group. Since the bailment process for OMO involving the secondary group entails payment of funds from the Primary Dealer to the Issuer, the risk of payment failure or reversal from a Primary Dealer may be greatly reduced from that of directly accepting payment from some other counterparty.

Assurance of an orderly market for currency exchange. The grant of privileges enabling OMO may be contractually linked to obligations assuring provision of an orderly market.

Compliance with Repository requirements. Given that: a) participation in the bullion Bailment or delivery processes may require a Primary Dealer to either maintain allocated storage on its own account in the Repositories where bullion reserves are held, or have a dealing relationship with a bullion dealer that does, and, b) Repositories and wholesale bullion dealers impose a high standard of due diligence on their prospective customers, any bailment arrangement involving a broader cohort of the general public would be impracticable.

Required for emergence. Additional Roles may be critical for emergence and sustainable functioning of the System as a viable global alternative to Currencies issued by government Monetary Authorities.

Financial Institutions. Members that are Financial Institutions may fulfill Roles that entail offering Currency exchange services to other Members.

Exchange Provider. Systems may provide for participating Financial Institutions to fulfill the Role of Exchange Provider.

Obligations. Obligations incurred by an entity seeking to act as a Depository Institution within the system may be memorialized in a contract such as a Supplemental Agreement for Depository Institutions as further detailed

### AML Safeguards.

Linking of Accounts. The technical protocol may require an Exchange Provider to implement measures by which each of their customers designates and demonstrates requisite control or ownership of a Linked Customer Account Module. Alternatively, this requirement may be met by means of System Provider identifying a Linked Customer Account Module as a component of data provided to its relying party in the course of federated log-in.

Prohibition of third party funding. The technical protocol may require an Exchange Provider not to accept a funding payment for any currency exchange transaction for which the funding or fulfillment payment is by means of a Spend from any party or source other than their exchange customer.

Depository Institution. Systems may provide for participating Financial Institutions to fulfill the Role of Depository Institution.

Obligations. Obligations incurred by an entity seeking to act as a Depository Institution within the system may be memorialized in a contract such as a Supplemental Agreement for Depository Institutions as further detailed herein.

Trademarks and terminology. System Provider may require a Depository Institution to abide by trademarks and consistent-use-of-terminology specifications of System Provider and of any Issuer the Base Money of which may serve as reserves/redemption medium underlying that Depository Institution's own BMP Account liabilities.

Funding and withdrawal. System Provider may require a Depository Institution to implement mechanisms enabling a BMP Account Funding Spend to be promptly credited as to properly increment the balance of the applicable BMP Account.

FIG. 11 shows a system 1100 whereby BMP Account Funding Spend 1103 creates an accounts payable liability on the part of the Bank to make an appropriate credit to their customer's BMP Account. Display 1101 displays a particular customer's balances of USD and of system-Issuer Currency XXX and corresponding states of the bank's simplified balance sheet 1102 Prior to the BMP Account Funding Spend comprising event 1103, customer balance display 1101-1 shows balances of 1,000 USD (a conventional deposit) and a zero balance of XXX, the denomination for this particular BMP Account. The bank's simplified balance sheet in this state 1102-1 shows a deposit liability of 1,000 USD offset by 1000 USD of assets. With event 1103, the customer makes a BMP Account Funding Spend in the amount of 2.0 XXX from customer's Account with the system to bank's designated Account with the system and a Spend Fee of 0.02 XXX id deducted from the recipient Account (i.e., the bank's). Upon receipt of this Spend, the corresponding balance sheet shows the net 1.98 XXX of new assets and incurs an accounts payable liability of 1.98 XXX. Event 1103 occurs entirely on the books of the bank. Customer interface 1101-3 shows 1.98 XXX posted to the customer's BMP Account. Balance sheet 1102-3 shows the account payable to have been satisfied, the liability having now been posted as 1.98 XXX of XXX-denominated BMP Account liabilities.

The Depository Institution may also be required to implement mechanisms for prompt initiation of a Withdrawal Spend in fulfillment of a BMP Account owner's order.

### AML Safeguards

Linking of Accounts. The technical protocol may require a Depository Institution to implement measures by which each of their customers designates and demonstrates requisite control or ownership of a Linked Customer Account Module. Alternatively, this requirement may be met by means of System Provider identifying a Linked Customer Account Module as a component of data provided to its relying party in the course of federated log-in.

Prohibition of third party Spends relating to a BMP Account. The technical protocol may require a Depository Institution to only accept BMP Funding Spends from and only direct Withdrawal Spends to their customer's Linked Customer Account Module.

IP Owner. In a preferred embodiment, the provision of separate ownership of the underlying intellectual property and a licensing arrangement whereby such IP may be provided to the System Provider and/or Issuers enables an additional check and balance tending to mitigate the risk of a System Provider or Issuer deviating from founding principles.

Right Holder. A Right Holder may be a Member that, in exchange for initial capital enabling establishment, launch and/or enhancement of the System, receives a continuing and transferable right to a specified portion of gross revenues generated by the System. The benefit due to a Right Holder may be partially determined by actions undertaken by that Right Holder to attract new Members to the System.

End User. The default Role for Members may be End User; this is for economic actors comprising the general public such as individuals, companies or government bodies that become Members but play no institutional Role relating to administering the system.

Members and Persons. FIG. 5 shows a system of classification of Persons and subsets of Persons 500 consists of Legal Persons 501 and Human Beings 502. All Users 503 are Human Beings 502. Applicants 504, Members 505 and Account Owners 506 may be either Human Beings 502 or Legal Persons 501 and an Account Owner 506 must be a Member 505. An Account User 507 must be a Member 505 and a User 503 and may or may not be an Account Owner 506, a Proxy 508 or a Root User 509. A Root User 509 must be an Account User 507. A Proxy 508 must be a Member 505 and a User 503 and may or may not be an Account Owner 506, an Account User 507 or a Root User 509.

Person. Systems may exist to build and maintain a registry of Natural Persons and Legal Persons worldwide, whether or not application has been made by or on behalf of such Person to participate in the system or that Person has directly interacted with the system. These systems may facilitate recognition of situations in which identifiers are being presented to the system that are erroneous (as with a misspelling), fabrications, or, stolen in the sense of their being used to misrepresent an identity.

Status of a Person. Systems may assign a status to each Person on record in the system which may be updated/modified and a record of all previous statuses and amendments maintained. An example of such status may be a Person banned from system participation because of previous misuse of the system that led to expulsion. Another example may a Legal Person such as corporation that has been dissolved. A status may be a composite of multiple axes.

Phantom. Systems may be implemented to accumulate identifiers that have been recognized as being fabricated or stolen, paired with data such as IP addresses, cookies and user-agent strings gathered during the access session in which they were presented, in order to develop profiles of individuals or automatons that repeatedly make false assertions relating to identity and facilitate their more efficient recognition upon return or their coalescence as and/or linkage to an actual Person attempting to misuse the system.

User. Systems may be implemented enabling a Natural Person to matriculate to the system as a User. Certain Users may only be granted Permissions to access the system from customer facing interfaces while other Users may have backend access enabling performance of system administrative tasks.

Log-in credentials. For a Natural Person to become a User the system provides for the establishment by that User of Log-In credentials specific to that User.

Hierarchical Permissions. Systems may provide for granting Permissions to Users. Such systems may be hierarchical in the sense that certain Permissions may invest a User with Privileges enabling the extension (or revocation) of specified Permissions to other Users.

Applicant. Systems may enable User submission of data regarding an Applicant and for the system to accumulate, track and review such data pending determination whether to grant Membership to the Applicant.

Member. Systems may provide for the enrollment of a Member and for the maintenance and updating of Member information.

Status of a Member. Systems may assign a status to each Member on record in the system which may be updated/modified and a record of all previous statuses and amendments maintained. An example of such status lineage may be a Member who had resigned his Membership and who later requested and was granted reinstatement.

Proxy. Systems may provide for designation of a Proxy and for the transfer or discontinuation of Proxy authority.

Account Owner. Subject to due diligence performed by the System Provider, a Member in good standing and residing in a jurisdiction where participation in the payment system is permitted may own one or more Accounts, solely or jointly with other Members.

Account User. A Member who is a User may be assigned Permissions as an Account User on one or more Accounts owned by himself or by (an) other Member(s). There may be multiple Users on an Account.

Root User. The system may require a Root User on each Account. At the time of Account creation the Root User may hold a full set of Permissions regarding that Account including the Privilege to appoint other Account Users and assign their Permissions.

Universal CIP. A universal prerequisite to Membership is successful completion of processes for establishing, documenting and verifying the identity of an Applicant. These processes may be styled a Customer Identification Program or CIP.

Documentary verification. CIP may entail User submission of original or facsimile images of documents substantiating identity and place of residence. Examples of an identity document may include a current government-issued identification card bearing a photograph such as a passport or driver license. A document demonstrating place of residence may be a copy of a utility bill. System provider personnel may evaluate submitted documents and make a determination that they are authentic and unaltered.

Non-documentary verification. Another verification technique may entail submitting a set of User-provided identifiers such as name, date of birth, government ID number and address to a commercial service that can determine how well they match known data on record.

OFAC. Systems may be implemented to comply with restrictions, sanctions, reporting requirements and/or other regulations imposed by the Office of Foreign Assets Control (OFAC) of the United States Treasury. Such compliance measures may include processes to screen both Applicants and existing Members to detect Persons who may be on the OFAC list of Specially Designated Nationals or who may be subject to other OFAC sanctions.

Remote video inspection. Systems may be implemented to perform the remote equivalent of on-site inspection of the premises of a business customer of the system. Such systems may entail a partially structured video interview combined with a facilities tour under the remote real-time guidance of trained System Provider personnel. A video file of the inspection may be retained both as documentation and also an investigative aid in the event of subsequent concerns of possible illicit activity involving the business.

Technical considerations. Since it would be substantially more difficult to fake an interview and inspection conducted in real-time response to a trained inspector, systems must support capture of telephonic communication in conjunction with the video footage, this combination essentially comprising a video call. Commercially available smart phones may be used at the customer end, in combination with software at the system end affording the ability to save the video call file in an auditable fashion precluding for example introduction of a faked or prerecorded file by an employee of the System Provider. This may require that the video call be initiated from the system side and conducted via a software interface to the system backend. The interface could invoke or integrate commercially available voice-over-IP/video call products such as Skype. The interface alone would implement the saga enabling the file to be persisted and associated with data identifying the date/time of interview, identity of interviewer and identity of both the human being and the business subject of the interview. The system may affix a digital signature to the file using a private key inaccessible to administrative personnel such as interviewers.

Structured elements. Capture of certain structured elements may be included in the basic script of all such video call remote inspections. These elements may include the human interviewee stating his or her name and turning the camera as to capture his or her own facial image. The interview may begin at the exterior entry point of the business premises, capturing any signage on nearby buildings and streets and a panoramic sweep of the exterior and neighboring structures. If the call drops at any time, additional calls may be initiated, as many as necessary. The interior of the business premises should be inspected with emphasis on areas where business activities characteristic of the business occur.

Ad hoc or discretionary elements. The interviewer may instruct the interviewee to capture additional footage and/or other data as might be judged useful by the interviewer. For example, with exterior footage, the interviewer may direct the interviewee to direct the camera to license plates in the parking lot and, if the licenses correlate poorly with the stated location of the business, ask the interviewee why the discrepancy exists. During the interior inspection, the interviewer may notice inbound postal mail and ask the interviewee to direct the camera as to show the address. To facilitate cooperation with these ad hoc elements, the interviewer may be trained in techniques to establish a degree of rapport between interviewer and interviewee. For example, in suitable contexts, establishment of a more lighthearted demeanor may facilitate capture of additional data such as co-workers that voluntarily want to be seen in the footage.

CDD. A universal prerequisite to Account Ownership is successful completion of processes for establishing, documenting and verifying the anticipated usage of an Account as well as an Account Owner's source of funds in order to aid in subsequent prevention, detection, interdiction and/or reporting of possible suspicious activity on the part of a customer or customers. These processes may be styled Customer Due Diligence or CDD.

Anticipated usage. Systems may be implemented for both individual and business Accounts for gathering and evaluating User-submitted data regarding anticipated usage. Universal parameters of anticipated usage may include an estimated range of the number of counterparties from whom Spends will be received and to whom Spends will be made, in addition to whether such counterparties may be domestic or international. A User may also be asked to estimate the quantity of value that may flow through an Account over a specified interval of time such as a typical month. For example, in the provisioning of a personal Account an anticipated usage that entails routinely making or receiving Spends to/from more than 100 counterparties may indicate an intention to use the Account for business purposes.

Source of funds. Systems may be implemented for both individual and business Accounts for gathering and evaluating User-submitted data regarding source and nature of income. In the case of an individual, systems may gather information regarding employment since that is the most common source of income for most people. For example, an unemployed student proposing to routinely receive large flows of value into a personal Account may warrant further evaluation to distinguish the wealthy beneficiary of a trust fund from a person involved in money laundering activities. Systems for evaluating the nature of a business may require gathering more extensive data regarding the particular business model. For example a manufacturing business that does not engage in retail sales to consumers but rather expects to receive occasional large business-to-business Spends would need to be distinguished from a professional practice that might similarly receive intermittent Spends in irregular amounts.

EDD. System usage by certain categories of individuals or business enterprises may constitute a heightened risk for money laundering or other abuses of the system. Systems of enhanced due diligence (“EDD”) may be implemented to gather and assess additional information regarding sources of income or particulars of the business model of such individuals or organizations. In the case of a high risk business, such as an Exchange Provider, these risks may arise not from ill intent on the part of the Member subject to EDD but rather from unwitting facilitation of abuses by customers of that Member. The process of EDD may be implemented in conjunction with specialized supplemental contracts between System Provider and Members subject to EDD specific to the risk profile and category of business activities of the Member. EDD may also be coordinated with assistance or use of specialized templates in Account Module provisioning. EDD may also integrate into rules-based Transaction Monitoring systems. For example, a rule may entail monitoring Spends to or from Exchange Providers to detect Members obtaining a Balance of one of the Base Moneys via currency exchange only to dispose of it shortly afterward via currency exchange with another Exchange Provider. Examples of EDD combined with specialized contracts and Account Module provisioning are detailed in the description of systems for Financial Institutions that matriculate to the system.

Privileges/Permissions. The system may govern all system interactions according to a Permissions model. Systems may afford mechanisms for assigning, modifying and operating in accordance with Permissions such that at any given time the system may individualize the system-interactive capabilities of each and every particular User.

Business rules. The system may include sub-systems enabling integration of business rules. The implementation may entail use of a rules engine permitting systematic integration of new rules, capabilities for rapid marshaling of all rules applicable to a particular system interaction, and mechanisms for assuring compliance with all applicable rules.

Internal controls. The system may embody internal controls assuring compliance with business rules relating to system integrity. Internal controls may entail defined processes such as procedures for manual tasks. Some internal controls may operate automatically as for example an Issuance saga designed to eliminate possibilities of error, malfeasance or coercion that could result in breach of an Issuer's Declaration of Liability such as over-Issue leading to un-backed Monetary Liabilities.

Interfaces. The system may implement systems to dynamically provision the User interface of each particular User for each logged-in session upon successful presentation and authentication of Log-In credentials with capabilities specific to that User's Privileges and assignment of Role responsibilities. This dynamic provisioning of interfaces on a User-specific, session-specific basis may serve to enhance security by precluding exercise of permissions reserved for other User/Roless. For example, certain web-based legacy systems may control access to backend or sensitive administrative functions by means of static webpages at URLs that may be secured by Username/password and possible implementation of digital certificates. Such URLs may become natural targets of hackers seeking to penetrate a system and gain access to functionality controlled via such webpages.

Contracts. The system may include a prescribed canon of contracts memorializing privileges and obligations enabling the various Members incumbent to each of the various Roles to interact with the system and each other as to assure consistent conformity to system logic. In all cases except for an IP License Agreement the System Provider may have primary responsibility to assure execution of contracts and to monitor the performance of contractual counterparties. In embodiments in which IP is owned by a separate IP Owner, the IP Owner may bear primary responsibility for assuring the execution and performance of the IP License Agreement.

Core logic. Certain contracts may serve such a foundational function as to be required for the system to be formed and operate.

Membership Agreement. A Membership Agreement may be provided specifying universal terms and conditions governing participation in the system.

Issuer's Declaration of Liability. Both general and more differentiated forms of an Issuer's Declaration of Liability may be provided specifying terms and conditions defining and governing the Monetary Liabilities of any Member undertaking to act as an Issuer via the system.

Contract Governing Issuance and Circulation. A contract may be provided governing the system interactions of an Issuer and the System Provider to provide for the Issuance and circulation of that Issuer's Monetary Liabilities.

Primary Dealer. A contract may be provided governing the rights and obligations of any Member undertaking to act as a Primary Dealer.

Additional and Preferred extensions. Certain additional contracts may be provided specifying terms and conditions that are preferred for expedience in implementing the system but may allow for somewhat greater latitude in their particulars. Examples of such contracts may include but are limited to: Conditions of Website Use, Privacy Policy, Referral Incentive Program Agreement and supplemental agreements governing system participation of Exchange Providers and Depository Institutions.

Revenue model. The system may seek to be commercially self-sustaining via systematic integration/implementation of a revenue model.

Source of revenues. In certain preferred embodiments, the system may decline to implement any revenue model that entails levying a Membership fee or imposing any other sort of charge or fee that might require the System Provider to accept payments or transfers of value in any form from the general public or Members via existing payment systems that rely on banks. This is not an obligatory element and certain embodiments may involve assessment and collection of membership fees.

Fees The System may generate revenue primarily by assessing two fees, collected by the System Provider.

Spend Fee. A Spend Fee may be deducted from the recipient Account of all Spends with the exception of: Issuance Spend, Redemption Spend, De-Issuance Spend or Spends between two Accounts in the same Account Module.

Account Maintenance Fee. An Account Maintenance Fee may be deducted from SubAccounts on the basis of a formula that is a function of Settled Balance and time. The SubAccounts of any Mint Account or Comptroller Account may be exempt from this fee.

Income generated by treasury function. An Issuer of Currencies in the secondary group may realize income from holdings of remunerative assets such as debt securities held against Monetary Liabilities.

Distribution. The system may implement a systematic schema for distribution of gross revenues between System Provider, Issuers and, in certain embodiments, Right Holders and/or the IP Owner.

### System Integrity

### General Considerations

Security of User access. Since the system may rely heavily on a Permissions logic that, with regard to all User interactions invokes a set of User-specific Permissions specific to each logged-in Session of that User, systems may be implemented to maximize security of User access.

Authorization and authentication. System may be provided for authenticating that any interaction with System is performed only by Person assigned Privileges for such access and interactions.

Password complexity. System may impose a complexity requirement for passwords, for example requiring a minimum length and a mixture of alpha and numeric characters.

Default security with optional increased rigor. The system may enable User adjustment of security settings to a higher level than the system imposed default. For example, the system may support usage of hardware tokens such as a smart card based log-in device involving a cryptographically enabled micro-chip for an End User preferring such an option.

Two (or more) factor authentication. System may impose systems for two or more factor authentication. An example might be a requirement for User entry of a PIN delivered by the system to the User's mobile phone via SMS message or a smart phone app.

Biometric authentication. System may implement capabilities for biometric authentication such as but not limited to a facial or iris recognition app for a smart phone or use of a hardware device for digital capture of fingerprints.

Association to a particular User device. Systems may associate a User with that User's computing device used for system access and issue an additional authentication challenge if another device is used seeking system access by someone purporting to be that User.

Automated access attempts. Systems may be deployed as countermeasures to foil automated access attempts such as automatons seeking to guess a password via a so-called dictionary attack or other brute force technique for trying multiple passwords.

Phishing. Systems may be implemented to safeguard against release of information that could marginally compromise the security of User Log-in credentials. For example, a would-be attacker might repetitively undertake to establish new Log-in profiles seeking to discover Usernames already in use on the system. To hinder such phishing expeditions rule sets such as the following may be provided: (1) if proposed Username is taken, the System may suggest several similar but unused variant(s), and/or (2) the system may impose a limit on number of unsuccessful tries within specified time interval.

Recovery of access. Systems for restoring User access in the event access is sought by someone claiming to be a User who has forgotten a password or lost an access token may be secured by imposing a multiple stage process for proving that the Person claiming to be a particular User is in fact that User.

Back end capability for restoring User access. Systems may be implemented to mitigate the risk that a rogue employee act as a confederate to someone seeking to exploit systems for recovery of access to gain unauthorized access to a User's Permission set.

Access logging. Systems may provide for automatic logging of all system accesses by customers or by backend administrative Users. Such logging may create an auditable record containing data fields including but not limited to identity of User, date and time of access, session information such as IP or identifiers specific to access device used, resources or systems accessed, nature of access (such as read-only vs. an interaction that changes the state of a system or object) and an association with the unique identifiers of any transactions conducted during the session by that User.

Data security. Systems may be provided to secure the system against unauthorized access or other breach of data security.

Physical and technical measures. Systems may be secured by systems including but not limited to: hardware and software firewalls, internal or third party systems to defend against denial-of-service attacks, use of hardened colocation facilities with redundant upstream internet access, backup power and systems for securing physical access.

Encryption. Personal information or other sensitive data such as passwords may be stored in encrypted form using a one way hash function. The robustness of the hashing protocol may be enhanced by salting as a safeguard against dictionary attacks. The salt may be unique per-user-per-password and may be generated using a Cryptographically Secure Pseudo-Random Number Generator (CSPRNG).

Federated Log-in. The system may implement federated Log-in capabilities and serve as a provider to approved relying parties. Provision of federated log-in services may enable relying parties to rely on the identity verification procedures universally required of Members. Such reliance may be used by relying parties, for example, as an age verification mechanism or as a means of assuring that a customer or other prospective transactional counterparty is resident in an approved jurisdiction.

Session. System may persist data regarding each session between the system and a device and/or User, associating that session to a User when possible or with any data submitted by or otherwise gathered from a device or Person in instances when no association to a known User can be established. Such session data may include but would not be limited to IP numbers, user-agent strings such as browser tags, and cookies.

### Core Institutional Roles

Separation of institutional/governance Roles. The concept of separation of roles may be integrated into the System at multiple levels for preserving System integrity against acts of malfeasance, error or external coercion. In general, any action requiring the authorization or collaboration of two or more parties is more robustly protected from these risks. An example of such separation may be a dual authorization requirement, from Issuer and an independent Escrow Agent, for release of assets from the custodial arrangements used for holding reserves.

Distribution of revenue vs. equity model. The system may eschew a conventional equity ownership model for the entities fulfilling certain core Roles, particularly that of System Provider and perhaps also the Issuer of the gold-linked Base Money. A revenue distribution model based on automatic distribution of gross revenues, as opposed to an equity model that concerns itself with distribution of profits, may afford improved ability to resist institutional drift or corrupting influences that could undermine the integrity of the system. For example, in a post-emergence setting in which widespread usage of the gold-linked Currency acts as an external constraint on government monetary and fiscal authorities, pressure could be applied to an equity-based company in the form of a takeover bid in an effort to compel the system to accept government debt instruments as an alternative to physical gold. Stakeholders with a revenue entitlement but no voting control such as Right Holders or the IP Owner pose less risk of killing such a golden goose for the sake of near term expedience.

Automated internal controls. Systems may be provided to automate internal controls in order to decrease reliance on business processes that depend on human performance and compliance.

Automated transparency. Systems may be provided for near-real-time publication of data regarding vital metrics such as the quantity of the various Base Moneys in circulation, the quantity and composition of reserves, and statistics regarding System usage, all serving as transparency measures to reinforce governance safeguards in certain embodiments.

### End User Activities

Non-duplication-One Person/One Member. Systems for validating identity of Members may incorporate logic for excluding duplicate/multiple enrollments. The system may implement this requirement (as well as articulate it in contracts and presentation materials) as a “One Person/One Member” rule. Such systems for excluding multiple enrollment, even if innocently undertaken—such as a User who has lost a password or access token and mistakenly applies for a new Membership rather than pursuing system-provided measures for recovering lost access—may facilitate measures to detect and foil attempts by proscribed Persons to obtain Membership. An example may be a Person who has been expelled from the system for suspicion of illicit activity who seeks to re-enroll using falsified and/or stolen identifiers.

Transaction Monitoring. Systems may be provided for transaction monitoring for purposes of detecting indices of possible money laundering, terrorist finance or other illicit activities.

Statistical. Systems for transaction monitoring may include capabilities for detecting deviation from established statistical patterns. For example, a personal Account previously observed to have minimal activity that then changes to a pattern of a) receiving an incoming Spend just within its inbound Throughput Limit, followed shortly afterward by b) distribution of the value via a relatively large number of small outbound Spends may suggest involvement in a Ponzi scheme and warrant greater attention to counterparty Accounts and their associated Owners/Users.

Rule/pattern-based. Systems for transaction monitoring may incorporate rule-based detection methods that monitor for patterns deemed to be associated with possible abuses. For example, an Account may be listed on Throughput Exception requests submitted by multiple prospective counterparties as the recipient or source of Spends classified as being gifts. Such a pattern may warrant further evaluation to determine if the Account is being used for different purposes than disclosed in CDD.

Integrated. System organization that entails a System Provider with ability to query Membership records in conjunction with monitoring transactional activity may afford greater capability of iteratively detecting both falsified identifiers and suspicious transaction patterns. For example, detection of transaction patterns suggestive of a possible Ponzi scheme may trigger re-evaluation of submitted identifiers associated with the suspect Accounts that reveals previously undisclosed linkages or ownership or control.

Forensic data. System design affording direct interaction of participants, including End Users, with the Settlement Platform may enable capture and analysis of forensic data that would otherwise be lost as occurs with systems that interpose financial intermediaries between End User and central mechanisms for processing payments. Such forensic data may consist of data submitted by or otherwise gathered from a device or Person and any associated session data.

Channelization. The system may implement systems to channelize User interactions with the system in order to prevent a wide range of potential problems. To channelize means to narrow the range of system interactions available to a User so as to foster best practices on the part of Users and preclude numerous patterns of behavior that could, if permitted, lead to a larger volume of unauthorized or erroneous Spends or constitute illicit activities on the part of Users. In relation to erroneous Spends, the goal of channelization may be to reduce the risk or error on the part of the payer by making the system more “idiot proof”, that is, by systematically identifying and limiting potential sources of error. Channelization is preventive and complementary to transaction monitoring which necessarily focuses on detecting activities after the fact. Channelizing the range of possible system interactions may make deviations easier to detect by narrowing the channels of transaction flow to relatively homogenous streams in which deviations stand out as more glaring.

Enhance security of value. Channelization may enhance prospects for recovery of value in cases such as compromise of a User's Log-in credentials that leads to an unauthorized Spend. For example, efforts of a hacker to exchange value stolen via such an unauthorized Spend for some form of Outside money may be severely impeded by controls that hinder unauthorized commercial provision of currency exchange services.

Prevent and detect illicit patterns of usage. Channelization may enable prevention of illicit activity and facilitate better detection of unusual activity that slips through.

Money laundering. Channelization may thwart efforts to launder money using the system by impeding placement, layering and integration of value derived from criminal activity. Systems may be implemented to prevent value derived from criminal activity external to the system from being exchanged for value that circulates internally. Other systems may prevent and detect patterns of disaggregation or re-aggregation of value streams respectively dividing large sums into multiple small flows seemingly under control of a large cohort of unrelated Persons or coalescing multiple such small sums into more convenient large accumulations. Systems may serve to prevent and detect such disaggregation or re-aggregation activities both at system boundaries—financial institutions providing currency exchange services—and internally.

System regulation of participating financial institutions. The system may implement systems regulating how participating Financial Institutions interact with the system and its broader community of Members. These systems may bolster the effectiveness of Financial Institutions' own programs for combatting fraud and dealing with money laundering risks. These systems of regulation may include but are not limited to systematic measures to channelize the transaction flows between Financial Institutions and their customers.

Restriction of financial provision to approved entities. The system may implement systems to detect and sanction unauthorized entities providing financial services to Members such as currency exchange or holding customer value on account. Systems for Throughput Exceptions and Account Modules, detailed below, may contain elements facilitating detection of such unauthorized activities.

EDD for Financial Institutions. Members indicating the intention to provide financial services via the system may be subject to specialized EDD tailored to the specificities of Financial Institutions.

Licensing. EDD for Financial Institutions may include documentation of compliance with applicable government registration and licensing requirements.

Scope of services. EDD for Financial Institutions may include detailed elucidation and documentation of the scope of services the institution proposes to provide via the system. For example, an Exchange Provider may be required to enumerate: jurisdictions in which they would operate and in which their customers may be located, all payment mechanisms by which they would accept or make payments of conventional money from/to their customers and all websites via which business with their customers may be transacted.

Existing AML programs. A focus of EDD may entail elaboration of the Financial Institutions' existing AML programs including policies and processes by which they determine the identity and source of funds of their customers.

Provisioning of specialized Account Modules. System Provider may assist and direct Financial Institutions in establishment and provisioning of their Account Modules. Elements of this provisioning may include but are not limited to assurance that the Financial Institution and/or the relevant Accounts of the Financial Institution appear properly in interface elements of other Members such as drop down lists, and are captured by queries relating to rule-based transaction monitoring and channelization rules regarding permissible counterparties for Spends to or from particular Account types.

Supplemental contracts. System Provider may require participating Financial Institutions to enter into supplemental contracts governing their conduct of operations relating to the system.

Federated Log-in. Systems may provide federated Log-in capabilities by means of which a Financial Institution may receive assertions regarding a Member logging into their system that may include but not be limited to identifying information and information regarding that Member's Accounts. For example, a Financial Institution may rely on assertions received via federated Log-in to comply with rules/restrictions relating to Linked Customer Account Modules.

Integration of AML programs. Systems may be implemented enabling System Provider to bolster the effectiveness of AML Programs of participating Financial Institutions. An example may be transaction monitoring to detect structuring exploits distributed between multiple providers of exchange services and therefore possibly undetectable by the individual institutions.

Information sharing. Participating Financial Institutions may be required to agree to and participate in information sharing arrangements with System Provider to facilitate detection, investigation, interdiction and/or reporting of potentially suspicious activities. When applicable, such information sharing may be conducted in accordance with section 314(b) of the USA PATRIOT Act and related FinCEN guidance.

Cooperation with Member expulsion. Systems may be provided for, and participating Financial Institutions may be required to cooperate with, expulsion of Members. Such expulsion may entail processes enabling System Provider to override control of any Accounts of the Member being expelled and to enter Currency Exchange orders on behalf of that Member as may be necessary for zero'ing out any Account Balances. Systems may implement an assignment logic to determine which Financial Institution is tasked with performance of any particular forced Currency exchange.

Throughput limits. Systems for impeding potential illicit customer activity may include Throughput Limits.

Throughput exceptions. Systems for granting Throughput Exceptions may allow for larger-than-routine Spends which not only do not compromise strategies for impeding illicit activity but elicit customer inputs that may aid in detecting otherwise hidden illicit patterns of usage. An example circumstance in which a Throughput Exception may be granted might be a User who wishes to exchange value that he has accumulated over time in a traditional savings or investment vehicle—in an amount significantly exceeding regular monthly income from disclosed sources—for a quantity of one of the Base Moneys that circulate within the System. In this example the requestor specifying the intention of entering into a Currency Exchange transaction may be prompted to designate the particular counterparty Account from which the exceptional Spend would be received. Potentially both parties of a larger, non-routine Spend may need to request Throughput Exceptions, enabling comparison of the stated purposes of payer and recipient.

Throughput Exception Request. Systems may provide interfaces for User submission of Throughput Exception Requests.

Reduce risk of erroneous Spend. Multiple systems may be implemented to reduce the likelihood of entry and/or execution of an erroneous Spend Instruction and, if an erroneous Spend occurs, to mitigate the damage.

Shopping Cart Interface. Spends resulting from instructions submitted via a Shopping Cart Interface may be less prone to error because they do not rely on the payer to manually specify the Spend parameters. Moreover, systems for provisioning the Account Module of an online merchant may channelize the configuration process for that merchant's Shopping Cart Interface so as to preclude specification of an erroneous recipient Account.

Spend Amount. Certain systems may serve as safeguards to forestall errors of Spend Amount.

Unrealistic Reference Exchange Rate. Systems may serve to reduce the risk that a grossly erroneous Reference Exchange Rate is set or that if such an error occurs it results in erroneous Spends.

Erroneous update of Reference Exchange Rates. The system for updating Reference Exchange Rates may integrate an alerting mechanism such that an attempted update that would result in change of a published rate in excess of a preset percentage triggers an alert and does not execute the rate update order without manual confirmation by a System administrator.

Spend preview. Submission, and/or construction of a Spend Instruction may lead to display of a Spend preview that includes any Reference Exchange Rate used in System calculation of Spend Amount, enhancing the likelihood of the User on the paying Account noticing the error and declining to commit the Spend.

Recipient Account. Certain systems may serve as safeguards to forestall errors in specifying recipient Account.

Account number. Rules for randomness and a large namespace domain for system generated Account numbers may reduce the risk of collision, that is, of an error in specifying recipient Account number actually matching any existing Account.

Account Module name. Display of recipient Account Module Name in a Spend Preview may provide an additional safeguard against error.

Account type. System channelization rules that automatically enforce the types of Accounts or even the specific Accounts that may make or receive Spends to/from other types of Accounts or specific Accounts may reduce the risk of error.

Account modules. The system may impose universal adoption of Account Modules as a means of channelizing the flow of Spends to, within and from the Accounts of a customer, particularly a business enterprise. Since the use of Account Modules entails obligatory use of multiple Accounts, the system may allow Spends between the Accounts of a particular Account Module to be free of Spend Fee and not to count against Throughput Limits.

Specialized Account types. Several Account types may be generally applicable to all types of businesses, including non-profit organizations or government entities.

Treasury Account. System may provide for Treasury Accounts. A Treasury Account, since it can neither receive nor make Spends from/to any Account external to its Account Module may be suited for holding the largest proportion of the overall Balances held by a business.

Receipts Account. System may provide for Receipts Accounts. Use of a Receipts Account as the only type of Account in an Account Module capable of receiving Spends from outside that Module may facilitate the ability of System Provider to determine whether Spends to a particular business enterprise are for a legitimate business purpose. For example, one receipts Account may be designated for use only for receiving Spends that constitute sales revenue from the customers of the business, while another Receipts Account might be used only for incoming Spends that are not sales revenue, such as refunds from a vendor or a capital contribution from an owner of the business. The business customer in turn may benefit from the utility of a Receipts Account for strengthening its own internal controls as described below.

SCI Receipts Account. A requirement may be imposed on any enterprise using the system to accept payment online via automated means such as a shopping cart to cause all such incoming spends to be directed to an SCI-receipts Account.

Disbursement Account. System may provide for Disbursement Accounts. Use of a Disbursement Account as the only type of Account in an Account Module capable of making Spends to Accounts outside that Module may facilitate the ability of System Provider to determine whether Spends from a particular business enterprise are for a legitimate business purpose. For example, a business purporting to engage in online merchandise sales but secretly intending to operate a Ponzi scheme would betray its activity by attempting, whether directly or through one or more intermediaries, to make payouts to a large cohort of third parties, perhaps in some cases overlapping with the cohort of third parties from which Spends were originally received into the Account Module.

Trading Account. System may provide for Trading Accounts as the only type of Account in an Account Module capable of making or receiving Spends to/from Financial Institutions. Imposition of Trading Accounts, especially in conjunction with the system of Throughput Limit Exception requests, may facilitate the ability of System Provider to detect unauthorized provision of financial services. Improved ability to both channelize Spends for activities such as currency exchange to authorized providers and to monitor them may also aid in detection of unusual patterns involving a single User frequenting multiple exchange providers and possibly warranting increased scrutiny.

Trading-Receipts Account. System may provide for Trading-Receipts Accounts.

Trading-Disbursement Account. System may provide for Trading-Disbursement Accounts.

Account creation wizard. The Account establishment and provisioning logic for business customers may be encapsulated in an Account creation wizard that guides the process in a convenient step-wise fashion. Since the complexity of provisioning the multiple Accounts of an Account Module may require more than one Session, the system may have the ability to save work in progress enabling the User to pick up where he or she left off.

System Provider review. Upon completion of the establishment and provisioning of an Account Module but prior to activation the system may impose a requirement for review by the System Provider from a due diligence perspective to determine if the Account Module is consistent with the business purposes asserted in CDD.

Account Module templates. The process for establishing an Account module may employ a range of templates defining the constituent Account types comprising an Account Module. There may be a default module specifying only a basic complement of Accounts and more differentiated or specialized modules for businesses determined to fall into designated categories.

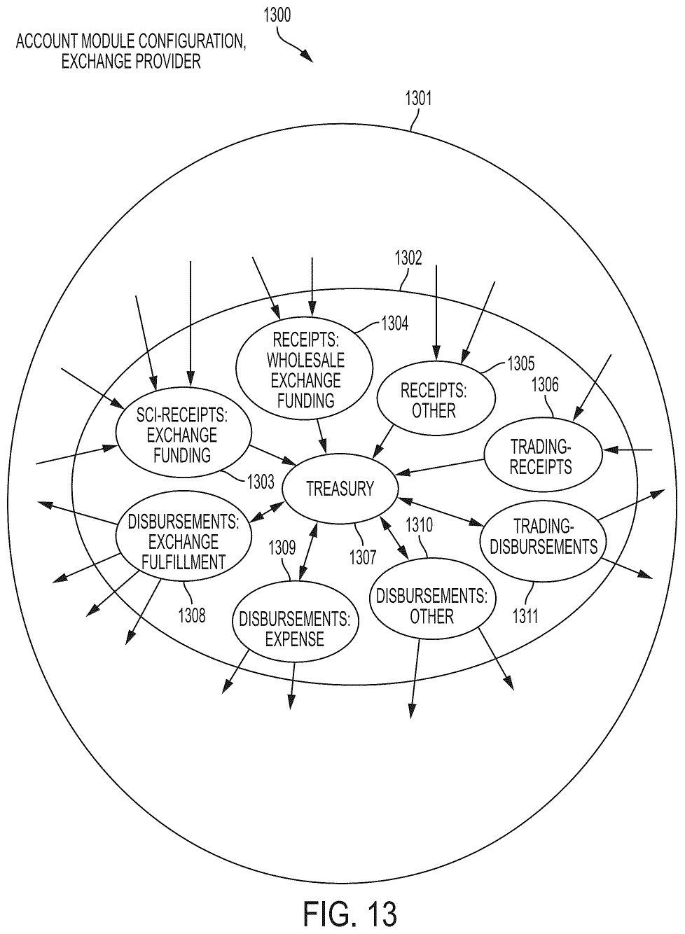

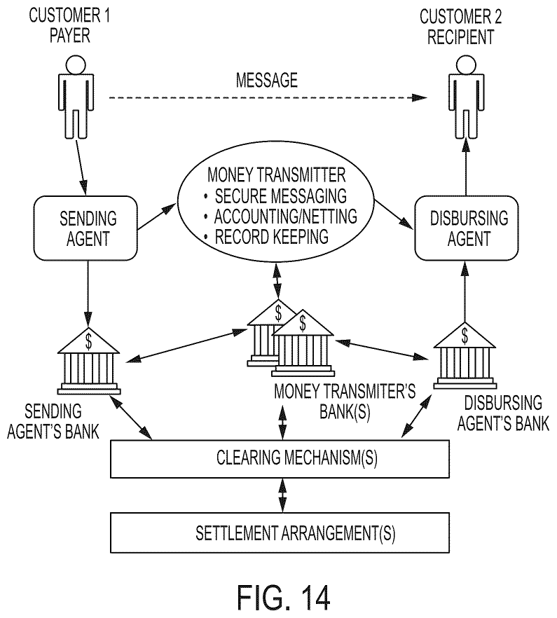

FIG. 13 shows a system 1300 of configuration for an Account Module 1302 for an Exchange Provider. Account Module 1302 and any Spends (represented by arrows) into or out of the Module are contained within the closed universe of Settlement Platform 1301. As shown, only Receipts Accounts such as 1303-1306 may receive Spends from Accounts external to Account Module 1302 and such Spends comprise the only mechanism whereby value may be conveyed into the module. Spends from Receipts Accounts 1303-1306 may only be made to Treasury Account 1307. Treasury Account 1307 is unable to directly receive or make Spends from/to any Account external to Account Module 1302. Treasury Account 1307 may receive Spends from any other Account within the module. Spends from Treasury Account 1307 may only be made to Disbursement Accounts with the same module such as Disbursement Accounts 1308-1311. Spends from Disbursement Accounts 1308-1311 may only be made to Accounts external to the module or to return value back to Treasury Account 1307. Only Receipts Accounts 1303 and 1304 may receive Spends that constitute the funding of exchange transactions in which the counterparty is not a Financial Institution. Spends to and from Accounts of other Financial Institutions may only be made or received respectively from and to Trading Accounts 1311 and 1306. Only Disbursement Account 1308 may be used to fulfill exchanges in which the counterparty is not a Financial Institution. Spends for paying expenses may only be made from Disbursement Account 1309.

Optional additional Accounts. The system may support the ability for a business to extend an Account module congruent with its own business requirements and system rules. For example, a single business may operate more than one website or may desire to segregate receipts from different product lines on a single website into separate SCI-Receipts Accounts

Account provisioning. System may provide for Account provisioning

SCI-Receipts Account. System may provide for binding an SCI-Receipts Account to a specific URL designated by the customer such that Shopping Cart Spends directed to the SCI-Receipts Account but originating from any other URL are not executed and instead generate an alert for possible evaluation by the System Provider.

### Account Module Benefits

Best practices. Imposition of Account Modules may enhance Account security by facilitating separation of roles within a business Member's organization. For example, a Permissions assignment logic that precludes any User on a Disbursements Account from being a User on the module's Treasury Account reduces the risk of loss due to malfeasance or compromise of any single User's Log-in credentials. The stringency of authentication settings on a Treasury Account could also be set higher, for example requiring the Spend instruction to come from a specific IP address and device such as a computer physically located in a secure area on the Member company's premises.

Facilitate monitoring to determine business purpose. The logic of provisioning of an Account Module may closely mirror the stated business activities of a Member and cause deviations from that stated purpose to be more readily evident. For example, a business that purports to receive its revenue from online sales conducted via a specific url that instead receives a large volume of Spends into a miscellaneous Receipts Account may be seeking to obscure illicit commerce behind the “front” of a legitimate business. In the case of such intentions, the very need to explain the need for a large Throughput Limit on such a miscellaneous Receipts Account may serve as a deterrent to a nefarious enterprise that that had established Membership with the intent of masking illicit revenues.

### Provision of Currency Exchange Services

Significance. A government Monetary Authority may introduce a new Currency into circulation by vesting it with legal tender status, mandatorily replacing the existing predecessor Currency. A would-be private sector Monetary Authority, in contrast, must rely on voluntary public demand. The primary channel by which such demand leads to an increased quantity in circulation is Currency exchange. Specifically, during growth in circulation, providers of Currency exchange services would tend to experience imbalances of demand—a larger volume of orders to exchange conventional money for the new money than vice versa—leading toward depletion of their trading balances of the new Currency, impelling them to replenish by themselves resorting as customers/price takers to (wholesale) exchange markets. In the disclosed system, this demand ultimately feeds back to Primary Dealers as they are the only exchange providers empowered to replenish their trading balances by causing new quantities of the demanded Currency to be issued.

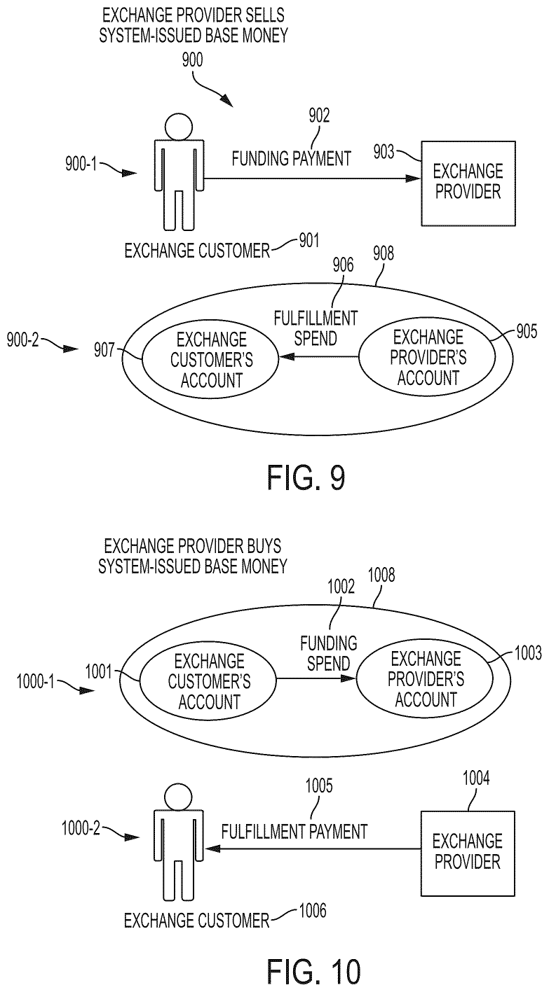

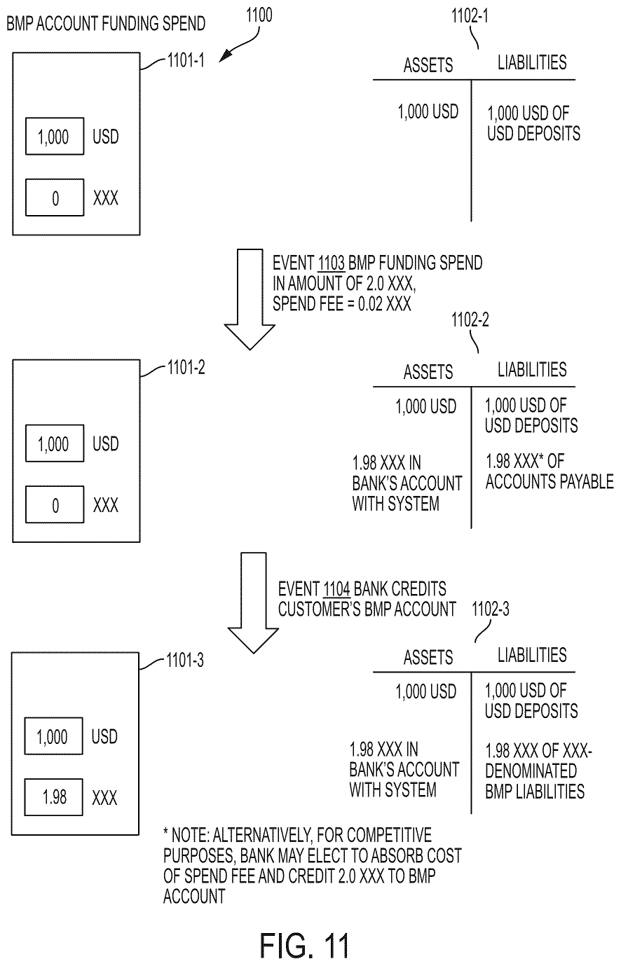

Exchange Provider. FIGS. 9 and 10 show Currency exchange transactions as performed by an Exchange provider as the combination of two payments, one a Spend within the system, the other a conventional payment of money external to the system. In all cases, after agreeing to terms of the exchange, the customer makes a funding payment in one Currency to the Exchange Provider. The Exchange Provider then makes a fulfillment payment to the Customer in the agreed upon fulfillment Currency.

FIG. 9 shows a system 900 for Currency exchange in which Exchange Customer buys a quantity of one of the system Base Moneys from Exchange Provider. The first payment 900-1 is Funding Payment 902 from Exchange Customer 901 to Exchange Provider 903 of conventional money via a mutually agreeable payment method external to the System. The second payment occurs internal to the System/Settlement Platform 908 as Exchange Provider makes Fulfillment Spend 906 from Exchange Provider's Account 905 to Exchange Customer's Account 907.

FIG. 10 shows a system 1000 for Currency exchange in which Exchange Customer sells a quantity of one of the system Base Moneys to Exchange Provider. The first payment 1000-1 occurs internal to the System/Settlement Platform 1008 as Exchange Customer makes Funding Spend 1002 from Exchange Customer's Account 1001 to Exchange Provider's Account 1003. The second payment 1000-2 is Fulfillment Payment 1005 from Exchange Provider 1004 to Exchange Customer 1006 of conventional money via a mutually agreeable payment method external to the System.

Depository Institution. The System enables participating Depository Institutions to provide currency exchange services entirely by means of book entries in their own accounting systems without necessarily needing to resort to Spends or other transactions involving their asset portfolio. Currency exchange as performed by a Depository Institution may be effected at the Broad Money level, that is, by exchanging a quantity of one of their own conventional deposit liabilities denominated in a conventional Currency for a quantity of one of their own BMP Account liabilities, denominated and payable in one of the system-provided Base Moneys and/or vice versa. As with provision of any multi-Currency account services, the Depository Institution may be able to take advantage of netting, that is, the cancelling out of offsetting credits and debits of multiple transactions involving transfers of their own liabilities, potentially enabling clearing of a large volume of exchanges with minimal or no obligatory resort to transactions to adjust their underlying asset portfolio.

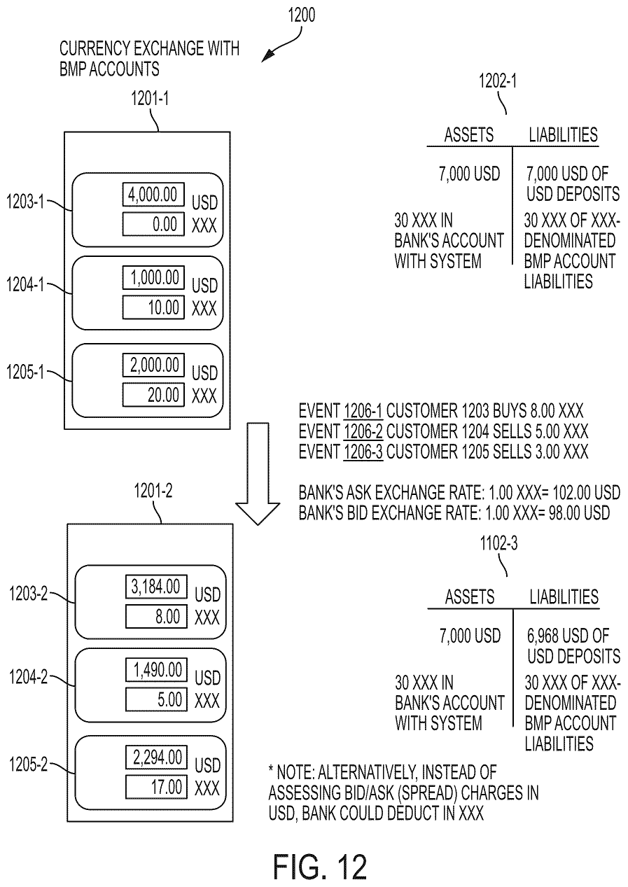

FIG. 12 shows a system 1200 whereby a participating Depository Institution exploits netting as it fulfills multiple Currency exchange orders involving BMP Accounts. Aggregate display 1200 shows a simplified online banking interface for three of its customers, 1203-1205 before (1201-1) and after (1201-2) each of them places, and the bank fulfills, Currency exchange orders involving their XXX-denominated BMP Accounts. The bank's simplified balance sheet 1202 is also displayed before (1202-1) and after (1202-2) events 1206-1-3. In aggregate, the bank is seen to sell a total of 8.00 XXX at its Ask Exchange Rate of 102.00 USD/1.00 XXX and buy a total of 8.00 XXX at its Bid Exchange Rate of 98.00 USD/1.00 XXX, realizing revenue of 8*4 USD=32.000 USD, entirely by automated book entry accounting operations without any need for adjustments to the bank's asset portfolio.

### Integration and Impact

Alternative, not replacement. The Base Moneys of the disclosed System, particularly those of the core group, may serve as alternatives that circulate more or less in parallel and play a complementary role to those Issued/administered by government Monetary Authorities. Under such a paradigm, government Currencies remain subject to sovereign prerogative and the side by side existence of both kinds of money afford flexibility and choice. The system may be implemented to facilitate and reinforce its integration as an alternative rather than as a replacement for existing monetary systems.

Unit of account. While many proposals of monetary reform or innovation emphasize money's “unit of account” role, that is, its usefulness as a pricing or invoicing unit, the disclosed system may be implemented in a fashion to explicitly encourage continued use of existing conventional numeraires. This strategy, supported by interfaces that influence User experience, may not only de-emphasize but possibly discourage use of the native units of account of the core group Base Moneys as pricing/invoicing units.

Support for novel indexed or basket units of account. Given that many esoteric proposals for monetary reform or innovation advocate use of indexed or basket units of account, the system may enable use of such units as Numeraire in order to demonstrate that they can readily be used without any need for actual new Currencies that implement such units as their native unit of account.

Medium of settlement. The system may be implemented in a fashion that strictly emphasizes its usefulness as both a medium and mechanism of payment, that is, a medium of (indirect) exchange and settlement.

Resource, rather than competitor. While the system's use as a payment mechanism may cause it to be perceived as a competitor to existing payment systems such as credit cards, it may be implemented and marketed as a resource to lower the costs and improve the profitability of any Financial Institution active in the payments arena. Paypal®, as one of innumerably many examples, faces limitations to its ability to lower costs due to the cost of interchange fees it incurs in the funding of payments. Use of the disclosed system as an alternative mode of funding payments may not only reduce such direct costs but may also diminish risk of payment repudiation affecting Paypal® and, consequently, its own (payment recipient) customers.

Relation to the gold standard. The disclosed system may ultimately afford global macroeconomic benefits similar to those of the classical gold standard, its institutions and operations, informed by analysis of the shortcomings of the gold standard and other historic and contemporary monetary paradigms, may be more robust and sustainable.

Efficient circulation of Base Money. While the gold standard was to significant extent automatically self-adjusting, the mechanisms of adjustment, such as the so-called “price-specie-flow mechanism (which depended on international bulk shipments of gold bullion) exhibited prolonged latency. Such adjustment processes were also vulnerable to a host of government measures undertaken to circumvent and/or neutralize them for extended periods. In contrast, the core self-adjustment mechanisms of the disclosed system derive from enabling the efficient flow of reserves into and out of the banking/financial system. These adjustment mechanisms, which may exhibit negligible latency and do not depend on governments playing by rules, would have been impracticable with the gold standard due to the disadvantages in using gold coins for day to day use in payments.

Price stability not a goal. Advocates of a gold standard are fixated on price stability, regarding it as a core goal of monetary arrangements. The disclosed system de-emphasizes use of the native unit of account of its core Currencies explicitly because of the potential for disruptive fluctuations in the value of gold and/or the other commodities used as backing that may occur incident to emergence of the system. While, paradoxically, greater price stability may eventually result such an effect would be subsequent to transitional effects and a consequence of successful “capture” (emergence of market driven influence over) government monetary and fiscal policies-outcomes that may take years or decades to manifest.

Finite gold supply. Detractors of a gold standard deride its imposition of an inflexible and arbitrarily selected constraint limiting the money supply. A near unanimous conclusion to analyses of why the gold standard was abandoned is that there simply was not enough gold for such a monetary regime to support the requirements of a modern economy. The disclosed system, in contrast, is implemented as an alternative that, rather than superseding or replacing conventional money, plays a supplemental role. If the scarcity of gold drives up the relative exchange value of the disclosed Currencies to levels making their use somehow inadvisable, people remain free to use whatever money they prefer. In the event of rise or fall in the relative exchange value of the disclosed Currencies, a Spend Instruction using a conventional Currency such as USD as Numeraire may simply convey a lesser or greater quantity respectively of the Settlement Currency.

Role of contract. The gold standard was a convention embraced by governments and abandoned when its obligations proved inconvenient. Private sector firms, in contrast, may be more effectively constrained by contracts, such as the Issuer's Declaration of Liability, a breach of which could prove ruinous.

Sovereign discretion. While the gold standard, when observed, did tend to constrain sovereign discretion with regard to monetary and fiscal policy, emergence of the disclosed system may not impinge on sovereign prerogatives or the insistence of electorates for magical suspension of economic cause and effect.

Automatic metering of money supply. The disclosed system enables alternative global Currencies the supply of which is automatically self-adjusting.

Base Money stocks. The ability of Primary Dealers to initiate Open Market Operations that result in either an increase or decrease in the quantity of Base Money in circulation in response to increased or decreased demand for such Currencies in currency exchange markets may enable automatic self-adjustment of Base Money stocks in perfect congruence with such market demand.

Broad Money. The system's unprecedented provision of an efficient remote payment system whereby the general public may make or receive payments without any obligatory financial intermediary enables the flow of Base Money into or out of the financial system thereby automatically metering interest rates and the Broad Money supply.

Embrace by financial system. The systematic capability of the system for administering Base Moneys that conform to the provided definition of Real Money may set the stage for Financial Institutions to embrace it and take advantage of its features in order to realize new avenues of profit.

### Imperatives Enabling Embrace.

Freedom from default risk. The freedom from default risk characterizing Base Moneys of the core group facilitates their embrace by Financial Institutions as a suitable reserve asset to be held against like-denominated bank deposits and other Broad Money liabilities.

Finality of settlement. The finality of settlement characterizing Spends facilitates usage of the system as a settlement platform underlying bank-administered payment systems and clearing mechanisms.

### Incentives for Embrace.

New fee-for-service revenue stream for banks. System support for participating Depository Institutions' provision of Currency exchange services affords them a new fee-based revenue opportunity. While many banks worldwide currently offer Currency exchange services it is quite uncommon for banks in the United States or other locations with strong domestic Currencies to offer online multi-Currency accounts to retail customers. Emergence of the disclosed Currencies may engender demand for such multi-Currency accounts and services.

Novel debt instruments and markets. While currently there is a paucity of financial intermediation and instruments involving gold debt, emergence of the disclosed system may lead to multiple corporate or even government entities with stable cash flows of the Currencies issued via this system. Such cash flows may pose an opportunity for financial intermediaries to foster emergence of debt instruments denominated and/or payable in the disclosed Currencies.

Global bank. The disclosed system may foster emergence of a global banking model, that is, banks capable of directly acquiring and serving customers from all over the world without obligatory need for Correspondent Banking relationships to accept deposits or fulfill withdrawals.

Domestic vs. foreign distinction rendered obsolete. The existing paradigm for banking embodies a distinction between “domestic” and “foreign” that stems from political compartmentalization of legacy (i.e., government-issued) Currency regimes and carries over to classification of bank/customer relationships as “onshore” and “offshore”. The artifact that perpetuates this distinction arises from the bank's need to maintain usage privileges on the settlement platform for electronic Base Money transfers of any Currency in which denomination it offers customer accounts, or to hold deposits with another depository institution that does. Such existing settlement platforms however are administered by government Monetary Authorities that only offer participation to domestic depository institutions. That restriction, in turn arises from the practice of government Monetary Authorities to extend credit and act as lender of last resort, services they uniformly restrict to depository institutions under their jurisdiction. The disclosed system may transcend this complex anachronism because it does not extend credit and can safely accept customers from around the world, thus potentially affording any bank anywhere with direct access to its Settlement Platform.

Correspondent banking obsolete. The need for Correspondent Banking may be eliminated. All Financial Institutions that meet Membership requirements may directly participate.

Global deposit and withdrawal, without intermediary. The system's provision of direct access both to participating banks and to their prospective customers enables unprecedented capability for the bank's customer to transmit a deposit or to receive payout of a withdrawal to/from such a bank without the delays, costs and risks attendant to every existing remote method of payment.

Reliance on federated log-in. The potentially daunting complexity faced by a bank undertaking to validate the identity and perform due diligence on prospective customers residing in multiple foreign jurisdictions may be solved by reliance on the federated log-in capabilities of the disclosed system.

### Consequences

Disintermediation. Emergence of the disclosed system and the attendant availability of efficient remote payments independent of the banking system may lead to an overall decrease in usage of banks.

Decreased amplification. Decreased use of banks may lead to decreased manifestation of the money-multiplier effect resulting in decreased amplitude of fluctuations in Broad Money supply.

Reduced moral hazard. Emergence of the disclosed system may counteract so-called “moral hazard” on the part of financial institutions, that is, a tendency to seek increased profit by engaging in higher risk activities when such risks can be externalized. An example would be a bank taking on riskier but higher yielding assets in the expectation of a government “bail out” in the event of losses potentially exceeding its capital resources.

No lender of last resort. Neither System Provider nor any Issuer may extend credit and are therefore precluded from acting as a lender of last (or any) resort.

Balance of Payment (BOP) considerations. The monetary and economic effects of international flows of money, conventionally examined from a “balance of payments” perspective, may be altered in a beneficial way in embodiments of the present invention, particularly with the gold-linked Currency. With legacy national Currencies, a strong balance of payments, i.e., an excess of inbound flows from foreign payers to domestic recipients, can lead to multiple complications such as appreciation of the exchange value of the domestic Currency unless measures to “sterilize” such flows are undertaken by the domestic Monetary Authority. This stems largely from the need to exchange foreign Currency for domestic, increasing the demand for the domestic Currency relative to the foreign Currency used to fund the payment. The disclosed System, in contrast, may simplify these considerations. Incoming flows do not necessarily require exchange into domestic Currency; incoming funds can readily be held on a distributed basis by the direct recipients without any obligatory involvement of domestic banks, correspondent banks in foreign countries, or the domestic government Monetary Authority. Likewise, spending any such accumulated balances by domestic payers to foreign recipients is an equally simple process. Any effects on relative exchange rates would involve gold and, presuming no nation eliminates its own Currency in favor of the disclosed gold-backed Currency, relative competitiveness is unaffected. Moreover, with the disclosed System, the anticipated typical practice of Users would be to price/invoice transactions using existing Currency units as Numeraire. Fluctuations in the relative exchange rate of the disclosed Currency would lead to an increase or decrease in wealth of its holders but would have no effect on the relative valuation of any national Currency relative to any other national Currency.

Post-emergence equilibrium. The ultimate goals the system targets are macroeconomic, to foster mechanisms for continuous market-based and -driven realization of: a) Natural Rates of Interest, and, b) a right-sizing of the State, the latter via, and as defined by, the assurance of sustainable fiscal policies. Achievement of both such endpoints may entail facilitation of market dynamics that impede discretionary manipulations of interest rates that might constitute deviations from natural rates of interest. While the system makes no provision for any process that may be construed as to supersede sovereign prerogative it may, through efficient channels of adjustment, foster generation of economic indicators suitable to be adopted as primary external benchmarks for guiding the conduct of discretionary government monetary policies.

Automated adjustments intrinsic to system. The system as noted provides processes enabling automatic market driven adjustment of the quantity of the system Base Moneys and interest rates at which Holders of such Base Money may be induced to loan it to financial intermediaries or other borrowers.

Channels of external transmission and adjustment. Widespread adoption of the system may give rise to emergent phenomena characterized by non-linear mutually interactive effects on exchange rates and a broad range of interest rates.

Exchange rates. Emergence of the disclosed system may afford global availability of a Currency relative to which the exchange value of national Currencies may decline when they pursue unsound policies. This would pose a striking departure from the existing international monetary order in which initiatives tending toward the debasement of one major national Currency ignite a pattern of competitive devaluation affecting all or virtually all other Currencies. Unmasking unsound monetary policies by enabling the exchange value of a conventional Currency to fall relative to a system-issued Currency, especially of the core group, may foster more prompt economic adjustments such an incremental rise in consumer prices instead of deferring adjustments until they can no longer be suppressed and the resultant dislocation and disruption is of greater magnitude.

Efficiency of currency exchange. A purpose for the second group of Currencies, those issued by a Currency Board or Boards anchored to major national Currencies, may be to facilitate efficiencies of Currency Exchange. These efficiencies may arise from the availability of Base Moneys that serve as a near-identical substitute for the designated national Currencies that can be conveyed via Spends. The efficient exchange of two Currencies, one the gold-based Base Money that optimally manifests the self-adjustment process disclosed herein, the other the perfect equivalent of USD, EUR or another major Currency, both of which can be transferred with immediate settlement, strong non-repudiation and extreme low transaction cost, is an efficacious mechanism for market based discovery of exchange rates.

Proliferation of online Currency exchange. Availability of the disclosed system, in and of itself, may cause a proliferation of online Currency exchange activity. One element may be increased demand for exchange in general as the community of Users grows and experiences needs to exchange their local conventional Currencies for system Currencies and vice versa. Another element may be the unprecedented technical ability for both payments of a Currency exchange transaction to be effected via Spends as in cases where secondary group Currencies are used as proxies for the Outside Moneys they are pegged to. Proliferation of online exchange is also a self-reinforcing process as increased exchange activity leads to improved liquidity of such exchanges.

Interest rates. Emergence of the disclosed system may facilitate exquisitely incremental market based feedback mechanisms that almost immediately affect interest rates in a manner that discourages governmental deviation from sound or sustainable monetary or fiscal policies.

Influence of Currency denomination on securities pricing. Effective interest rates of debt securities issued by any particular private sector debtor that are of identical maturity but are denominated in different Currencies may diverge due to perceived differences in the future prospects of those Currencies for maintaining their value. For example, following emergence of the system, a corporation with stable cash flows of the disclosed gold-linked Currency may discover lower borrowing costs for securities denominated in that Currency than for similar securities denominated in a legacy Currency. Such a discrepancy may serve as a powerful feedback mechanism tending to induce the Issuer of the legacy Currency to better track the system's gold-linked Currency.

### Gold Price

Transitional effect. Emergence of the disclosed System is likely to be accompanied by or even give rise to transitional effects that are themselves highly disruptive. Large scale Bailments of gold into the reserves underlying the disclosed gold-linked Base Money may lead to large changes in the valuation of gold relative to existing Currencies akin to what one might imagine occurring when a “corner” is established in certain commodity markets. While such transitional effects could lead to dire pronouncements about an insufficiency of gold, the System is designed to foster eventual re-establishment of a new equilibrium, albeit likely at exchange rates not previously observed relative to USD, EUR and other legacy Currencies.

Currency board tail wags dog. The System may enable Currencies of the secondary group, issued by Currency Boards, to circulate as a global Currency in certain embodiments. The transactional advantages of Spends over conventional modalities of payment, combined with system emergence that might lead to a very large community of Members, may enable the currency board to attain a global circulation that rivals that of the Outside Money it is anchored to.

It is understood that one or more steps of the method described herein can be accomplished outside of the U.S. One or more resulting determinations and/or calculations can be sent remotely to the U.S. through the web, via phone line, or any other form of common carrier or communication system. Furthermore, one or more components of a system may be located outside the U.S. with the results of determinations and/or calculations communicated to the U.S.

### Definitions

Account means a mechanism integral to the Settlement Platform serving as a means for (a) specified Account Owner(s) to hold quantities of the Base Moneys that circulate on the Settlement Platform thereby enabling the Account Owner(s) to receive Spends and, via an Account User authorized by the Account Owner(s), to make Spends.

Available Balance means the Balance in a Subaccount minus accrued liability for Account Maintenance Fee and any Holds.

Account Module means a constellation of Accounts consisting of either: a single Treasury Account and all non-Treasury Accounts to or from which Spends from or to that Treasury Account may be made or received, or, a Personal Account and its associated Referral Incentive Receipts Account.

Account Owner means a Member who/that alone or jointly with one or more other Members owns an Account.

Account User means a User who is a Member and who is authorized to Log-in as himself to the System and exercise Permissions that have been granted to him and not revoked relating to particular Accounts.

Applicant means a Person on whose or which behalf the Person himself or a Proxy has submitted an application for Membership and who/which has not yet been accepted as a Member.

To Bail means for a Person, the Bailor, to surrender property to the custody of another Person, the Bailee, resulting in a Bailment.

Bailment means the act of Bailing and the resulting obligation on the part of the Bailee to hold the Bailed property for the purpose specified by agreement of the Bailor and Bailee and not to use it for any other purpose such as loaning it to a third party or encumbering it as security for a debt.

Balance, without further specification, means Settled Balance.

Base Money means Monetary Liabilities of an Issuer serving as the medium in which like-denominated Broad Money is payable.

Broad Money means Monetary Liabilities of an institution other than an Issuer.

Broad Money Product Account (or BMP Account) means a product offered by a Depository Institution by which the Depository Institution holds a balance or balances, denominated in one or more of the Currencies the Base Moneys of which circulate on the System, on account for its customer constituting liability(ies) of the Depository Institution payable to its customer either on demand or at maturity via a Withdrawal Spend of the Base Money of the Currency in which the BMP Account or subaccount is denominated.

BMP Funding Spend means a Spend to an SCI-Receipts Account belonging to a Depository Institution for further credit to a particular BMP Account.

Comptroller means a Role requiring performance of operations involving a Comptroller Account for the Distribution and Redemption of the Base Money of a particular Currency.

Comptroller Account means an Account, belonging to an Issuer, designated as the sole Account permitted to receive Issuance Spends or to make Disbursement Spends involving a particular Currency. A Comptroller Account is exempt from Account Maintenance Fees.

Correspondent Banking means a relationship between a pair of banks—neither of which are a Monetary Authority—in which deposits at one bank serve as reserves for the other.

Currency means a distinct brand of money.

De-Issuance means the process by which Base Money is retired and extinguished such that it no longer exists.

De-Issuance Spend means a Spend in which the Comptroller Account for a particular Currency is the paying Account and the Mint Account for that same Currency is the receiving Account resulting in De-Issuance of a quantity of Base Money for that Currency equal to the amount of the Spend.

Delivery Instruction means an instruction to a Repository to remove designated assets from the custodial arrangements that enable their function as reserves underlying a particular Base Money and deliver them to the custody of a designated Person.

Delivery Order means a Delivery Instruction that has been authorized in accordance with System requirements.

Depository Institution means a Financial Institution that has been Authorized by the System Provider to engage, as a business, in holding value on account for their customers the liability for which is payable via a Spend or which is offset on their balance sheet in part or in whole by assets comprised of a Balance or Balances held in Accounts.

Disbursement Account means an Account that can only be used to make Spends to Accounts in other Account Modules and to make and receive Spends to or from the Treasury Account in the same Account Module.

Disputed Spend means a Spend that an Account User on the payer or recipient Account claims was made, or which the System Provider determines may have been made, without proper authorization or for which the Spend Instruction was authorized but erroneous. A Disputed Spend also means a subsequent Spend from the recipient Account of a Disputed Spend which the System Provider in its sole judgment determines may constitute an attempt to wrongfully profit from the Disputed Spend.

Distribution means the process by which newly Issued Base Money is distributed to the Primary Dealer on whose behalf it was created.

Distribution Spend means a Spend from a Comptroller Account to an Account of a Primary Dealer.

End User means any User acting otherwise than pursuant to a Specialized Role.

Erroneous means with respect to a Spend a Spend that was authorized by an Account User with the requisite Permissions on the paying Account but for which the Spend instruction contained an error causing it to be directed to the wrong recipient Account.

Exchange Provider means a Financial Institution that has been authorized by the System Provider to engage, as a business, in the provision of Currency exchange services that require the making or receiving of Spends.

A Hold means a restriction applied by the System Provider to a Subaccount that has been the recipient of a Disputed Spend that prevents a quantity of the relevant Currency equal to the lesser of the:
Available Balance, or,
Amount of the Disputed Spend minus the associated Spend Fee minus any accrued Account Maintenance Fee derived from the increment of Settled Balance due to the Disputed Spend,

from being available for Spending.

A Holder means any Member who/that elects to acquire, accept, or otherwise receive or own a quantity of Base Money in circulation within the System.

Identifier means an item of information such as but not limited to name, address, government issued identification number, date of birth (or incorporation), contact information, knowledge the possession of which is specific to an individual, biometric data, or documents that may be used to establish or verify the identity of a Person.

Issuance means the process by which Base Money is created.

Issuance Spend means a Spend in which the Mint Account for a particular Currency is the paying Account and the Comptroller Account for that same Currency is the receiving Account resulting in Issuance of a quantity of Base Money for that Currency equal to the amount of the Spend.

Issuer means a Member assigned and bearing responsibility for the Roles of Mint and Comptroller for a particular Currency.

Issuer's Declaration of Liability means a contractual declaration of liability defining a particular Base Money proffered by the Issuer of that Base Money and accepted by a prospective Holder.

Legal Person means any Person, such as but not limited to a corporation, trust or government entity, that is not a Natural Person.

Linked Customer Account Module means a designated Account Module the Account Owner or set of Account Owners of which is/includes the/an owner of a linked BMP Account or the linked Principal for whose/which benefit an Exchange Provider provides services.

Log-In means a process in which Log-In Credentials are presented.

Log-In Credentials means a set.

A Mass Spend means a Spend in which there is one paying Account and multiple recipient Accounts.

Member means a Person that has been granted Permissions by the System Provider enabling participation in the System.

Mint means a Role requiring performance of operations as the Account User of a Mint Account for the Issuance and De-Issuance of the Base Money of a particular Currency.

Mint Account means a special account on the Settlement Platform, belonging to an Issuer, the absolute value of each Subaccount balance of which equals the combined sum of the Settled Balances of all like-denominated Subaccounts. A Mint Account is exempt from Account Maintenance Fees.

Monetary Authority means an integrated system for the Issuance, Holding, Circulation and De-Issuance of the Base Money of a Currency accorded the status of Real Money, comprised of one or more Persons acting in the Roles of Issuer and System Provider.

Monetary Liabilities means liabilities denominated in the unit of account particular to a Currency and issued to serve as a medium of exchange.

Native Unit of Account means the Unit of Account specific to a particular Currency.

Natural Rate of Interest means an interest rate that influences the allocation of resources between current consumption and investment for the future such that demand for investment funds is matched by saving to fund the investments.

Natural Person means a human being.

Numeraire means the Unit of Account of a specified Currency designated as the basis for calculation of a quantity of a Currency which may be the same or a different Currency.

One person, One Member Rule means a rule that any particular Person may participate in the System as one and only one Member.

Open Market Operations means the actions of a Primary Dealer, specifically to Bail or Redeem in accordance with provisions set forth in an Issuer's Declaration of Liability for a particular Base Money and applicable agreements between the Primary Dealer and the System Provider, which lead to an obligation on the part of that Issuer to respectively increase or decrease the amount of that particular Base Money in Circulation.

Outside Money means with respect to the System any and all types of money or value in any form other than the Base Moneys that Circulate within the System. With respect to a Currency Board it means a Currency other than that Issued by the Currency Board.

Person means a unique human being or other entity who or that has been assigned a unique number such as a tax identification number by a government or is itself a government.

Permission means a right granted by the System Provider or a delegate of the System Provider enabling exercise of a specified Privilege.

Primary Dealer means the Role, and a Holder who has been granted the requisite rights and Permissions to perform that Role, bearing responsibility to conduct Open Market Operations for a specific Currency.

Privilege means a specified capability for interacting with System resources.

Proxy means a Member who is a User acting on behalf of another Person with regard to that Person's status as an Applicant or Member.

Real Money means a Currency, of which:
Some or all Monetary Liabilities denominated in it are suitable for general use as a medium of exchange,
No Monetary Liabilities denominated in it can be construed as Broad Money of another Currency,
The Base Money is suitable to be held by financial institutions as a reserve against like denominated Broad Money obligations such as bank deposits,
The Base Money is backed at all times by liquid assets held in readiness and in sufficient quantity as to assure its Issuer's ability to buy back all that has been spent into circulation.

Receipts Account means an Account that can only receive Spends from an Account in a different Account Module and can only make Spends to the Treasury Account in its own Account Module.

To Redeem means for a Holder of a particular Currency and the Issuer of that Currency, each from their reciprocal perspective, to engage in Redemption.

Redemption means the process by which the Holder of a quantity of Base Money may return it to its Issuer and receive in exchange a quantity of assets as specified in that Issuer's Declaration of Liability.

Redemption Spend means a Spend undertaken on the authority of a Primary Dealer for the purpose of Redemption in which an Account belonging to that Primary Dealer for a particular Currency is the paying Account and the Comptroller Account for that same Currency is the receiving Account.

Reference Exchange Rate means an exchange rate provided by System Provider for Member convenience for purposes of expressing an approximately equivalent value for a Subaccount balance or a quantity conveyed via a Spend in terms of a Numeraire that differs from the Native Unit of Account of the Settlement Currency.

Referral Incentive Receipts Account means

Reserves Store means an online store offered by an Issuer and accessible only by a Primary Dealer enabling the designation of specific reserve assets to be delivered in fulfillment of a Redemption contemplated by that Primary Dealer enabling System to automatically enforce internal controls implemented to prevent breach of the applicable Issuer's Declaration of Liability.

Role means a defined set of functions, privileges and obligations assigned to and assumed by a designated Person or category of Persons.

Root User means the Account User who creates an Account or a successor who has been designated by the Root User on an Account and who has acknowledged and accepted the designation.

SCI Receipts Account means a Receipts Account that can only receive Spends generated via a Shopping Cart Interface.

Secure Area means any System Resources that are only accessible to a logged-in User.

Settlement Currency means the Currency a quantity of which comprises the Balance in a Subaccount or is conveyed in a Spend.

Shopping Cart Interface means an interface enabling a Spend Instruction generated from a specified url of a specified Internet Merchant, Exchange Provider or Depository Institution to be accepted by the System for processing and, if conforming to System rules, executed.

Specialized Role means a Role other than End user that is required for the governance or orderly function of the System.

Spend means an Account-to-Account transfer, effected by book entry crediting the Account of the payer and debiting the Account(s) of the recipient(s) in an atomic transaction in fulfillment of a Spend Instruction that has been authorized in advance by an authorized User on the paying Account with said authorization communicated directly and securely from payer to System and Authenticated by the System.

Spend Amount means the quantity of Settlement Currency conveyed or to be conveyed in a Spend.

Spend Instruction means an instruction specifying the parameters of a Spend.

Strict Debit Rule means a programmatically enforced rule that a Spend Instruction specifying a Spend Amount that is greater than the Available Balance in the paying Account will not be executed.

SubAccount means a Currency-specific subdivision of an Account. For example, an Account may entail one SubAccount for the disclosed gold-linked Currency and another for the disclosed Currency that is anchored to USD.

System means the system and method disclosed in this document.

System Provider means the Person responsible for assuring all aspects of the integrity of the System other than liabilities and other responsibilities assigned by contract to Persons designated to fulfill other Roles. The System Provider provides for operation and administration of the Settlement Platform, and is responsible for assigning and/or approving all Privileges that enable other Persons to act in designated Roles.

Throughput Exception means an exception to a Throughput Limit such that a single Spend conforming to the parameters of a Throughput Exception Request that has been approved by the System Provider and has not expired is not counted against the Throughput Limit of the Account Module for which the Throughput Exception Request was granted.

Throughput Exception Request means a request submitted with respect to a particular Account Module for a Throughput Exception, specifying for the anticipated subject Spend whether inbound or outbound, the counterparty Account, the purpose and maximum Spend Amount.

Throughput Limit means a limit placed by System Provider specifying an amount determined by System Provider that can be received by Spends into or Spent from a particular Account Module during a specified interval of time.

Trading-Disbursement Account means a Disbursement Account outgoing Spends from which, with the exception of Spends to the Treasury Account in the same Account Module, can only be made to an Account in an Account Module belonging to a Financial Institution or, in the case of a Trading-Disbursement Account belonging to a Primary Dealer, to a Comptroller Account.

Trading-Receipts Account means a Receipts Account incoming Spends to which can come only from an Account in an Account Module belonging to a Financial Institution or, in the case of a Trading-Receipts Account belonging to a Primary Dealer, from a Comptroller Account.

Treasury Account means an Account that can only make or receive Spends to/from other Accounts in the same Account Module.

Unauthorized Spend means a Spend the Spend instruction of which was accepted by the System as authorized and executed but is subsequently determined to have been submitted.

User means a Natural Person who has submitted a unique Username to the System, successfully associated a password and any other required Log-in credentials with that Username, and made representation that any Identifiers they present as identifying themselves are valid and do not constitute an attempt to violate or circumvent the One Person, One Member Rule and who, upon presentation of Log-In Credentials and the System Provider's authentication and approval of same, is permitted to exercise specified Privileges.

Visitor means a Person that accesses resources of the System for which Log-In is not required.

Website User means a User that is not an Applicant or Member.

Withdrawal Disbursement Account means a designated Disbursement Account in the Account Module of a Depository Institution from and only from which Withdrawal Spends may be made.

Withdrawal Spend means a Spend from a Withdrawal Disbursement Account to an Account in a Linked Customer Account Module in fulfillment of a withdrawal order involving a BMP Account.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

1-65. (canceled)

66. A system for administering a closed alternative currency, the system comprising:
at least one processor and at least one memory, wherein the at least one processors perform the following steps:
providing access to one or more currency issuer users;
receiving requests for one or more issuance transactions with at least one of the one or more currency issuer users to issue or de-issue a quantity of a base money, wherein the base money is commodity-based and 100% reserved, and wherein the base money must come only from an account that already possesses adequate base money;
authenticating the one or more issuance transactions;
authorizing the one or more issuance transactions, if authenticated;
providing access to a plurality of account owner users;
receiving requests from one or more account owner users to add a quantity of base money to an end user account;
authenticating the request to add a quantity of base money;
authorizing the request to add a quantity of base money, if authenticated;
receiving requests from one or more account owner users to remove a quantity of base money to an end user account;
authenticating the request to remove a quantity of base money;
authorizing the request to remove a quantity of base money, if authenticated;
receiving requests for one or more payment transactions between account owner users in a base money;
authenticating the one or more payment transactions;
authorizing the one or more payment transactions if authenticated;
wherein the system is a closed system where base money cannot leave and outside money cannot enter.

67. The system of claim 66, wherein the one or more payment transactions is an account to account to transfer effected by crediting the account of a payer and debiting the account of a payee.

68. The system of claim 66, wherein the base money is in the form of a book entry in an accounting system accessed by the at least one processor.

69. The system of claim 66, wherein the issuer user must redeem and de-issue any or all base money on demand.

70. The system of claim 66, wherein the issuer user must issue additional base money on demand.

71. The system of claim 66, wherein the base money must not be loaned, hypothecated or encumbered for any purpose.

72. The system of claim 66, wherein a secondary currency circulates in the system, but is not commingled with the base money, wherein the secondary currency is backed at least in part by financial instruments and is anchored to existing national currencies.

73. The system of claim 66, further comprising enrolling system users after assuring validation of identity and excluding multiple enrollments or usage by proscribed persons.

74. The system of claim 66, further comprising authenticating the request for one or more payment transactions is authorized by an account owner user with requisite privileges.

75. The system of claim 66, wherein the commodity is gold.

76. The system of claim 66, further comprising:
receiving requests for one or more payment transactions between account owner users in a secondary currency;
authenticating the one or more payment transactions; and
authorizing the one or more payment transactions if authenticated.

77. The system of claim 66, further comprising exchanging currency from a convention currency to the base money or from the base money to the conventional currency.

78. An alternative currency payment system, the system comprising:
at least one processor and at least one memory, wherein the at least one processors perform the following steps:
providing a settlement platform for managing one or more accounts;
receiving one or more requests from a user to make or receive a spend instruction in a quantity of base money, wherein the base money is commodity-based and 100% reserved, and wherein the base money must come only from an account that already possesses adequate base money;
analyzing acceptability of potential spend instructions;
authenticating a spend instruction by determining if the spend instruction conforms to rules of the system.

79. The system of claim 78, further comprising:
receiving instructions from one or more issuers to issue or de-issue a quantity of base money;
authenticating the one or more requests to issue or de-issue a quantity of base money; and
authorizing the one or more requests to issue or de-issue a quantity of base money if authenticated.

80. The system of claim 78, wherein the spend instruction is an immediate automated settlement available at any time.

81. The system of claim 78, wherein the spend instruction is pre-authorized for a future time.

82. The system of claim 78, wherein the rules are a strict debit rule prohibiting a spend amount greater than an available balance.

83. An alternative currency issuance system, the system comprising:
at least one processor and at least one memory, wherein the at least one processors perform the following steps:
providing an issuance platform for managing one or more accounts;
receiving a bailment of a physical commodity to an allocated storage holding;
sending a notification of the bailment to an issuing user;
wherein an issuer spend is made from a mint account to a comptroller account; and
a distribution spend is made to an account of a primary dealer receiving the bailment.

84. The system of claim 83, wherein a quantity of base money is de-issued.

85. The system of claim 84, wherein the issuance platform performs a de-issuance, wherein the de-issuance comprises:
receiving a de-issuance spend from a primary dealer account to an account of a comptroller,
transferring the de-issuance spend from the comptroller account to a mint account resulting in a decrease of the base money in circulation; and
providing for release of the physical commodity from the allocated storage holding.
